(19) United States
(12) Patent Application Publication
(10) Pub. No.: US 2021/0203185 A1
(43) Pub. Date: Jul. 1, 2021

(54) POWER DISTRIBUTION SYSTEMS AND METHODS

(71) Applicant: Emera Technologies LLC, Tampa, FL (US)

(72) Inventors: Robert Ross Bennett, Tampa, FL (US); Luis Eduardo Zubieta, Oakville (CA)

(73) Assignee: Emera Technologies LLC, Tampa, FL (US)

(21) Appl. No.: 16/926,480

(22) Filed: Jul. 10, 2020

Related U.S. Application Data
(60) Provisional application No. 62/955,736, filed on Dec. 31, 2019.
(60) Provisional application No. 62/955,757, filed on Dec. 31, 2019.

(51) Int. Cl. H02J 13/00

(52) U.S. Cl. CPC H02J 13/00016; H02J 13/00028; H02J 13/00002

(57) ABSTRACT

A community DC power distribution system is provided including a community node comprising a voltage source, a first switch, and a second switch; and a power distribution loop. The power distribution loop can include power distribution lines. First power distribution lines can be grounded through first sensor resistors and electrically connected to the first switch, first local nodes, and a third switch. Second power distribution lines can be grounded through second sensor resistors and electrically connected to the second switch, second local nodes, and the third switch. The community node can be configured to provide power (i) to the first local nodes via the first power distribution lines and the first switch when the first switch is in a closed state; and (ii) to the second local nodes via the second power distribution lines and the second switch when the second switch is in a closed state.

### CROSS-REFERENCE TO RELATED APPLICATION(S)

This application claims the benefit of U.S. Provisional Application No. 62/955,736, entitled “Power Distribution Systems and Methods,” filed Dec. 31, 2019, and of U.S. Provisional Application No. 62/955,757, entitled “Backup Controller for Power System Management”, filed Dec. 31, 2019. The contents of these provisional applications are incorporated herein by reference in their entireties.

### BACKGROUND

Distributed energy generation and storage resources can complicate the management of power distribution systems. Distributed energy generation can increase the coordination and information gathered burdens on a power distribution system, as the overall generation of power must be coordinated to match the overall power consumption. Distributed energy storage resources (whether independent from, or associated with distributed generation systems) can create an additional level of complexity, as these energy storage resources may have operational requirements (e.g., maximum or minimum state of charge, charging or discharging rates, or the like) that are contrary to the overall needs of the power system.

Three main control concepts can be used to manage power systems: centralized control, distributed control, and decentralized control. However, these control concepts can be unsuitable for managing power distribution systems including distributed energy generation and storage resources.

A centralized control system can use a central computer system to collect information pertinent to elements connected to a power distribution system. Such a system may be used when electrical power flows from large central resources to consumers and any necessary management information can be collected and processed by the central computer system. However, a centralized control system may be unsuitable for managing distributed generation or storage resources requiring rapid management (e.g., on a sub-second time scale), due to communications latency and the control algorithm execution time. Furthermore, a centralized control system may be inflexible, as the centralized control system may need to be changed to address changes in number, size, or characteristics of controlled elements. Additionally, the centralized control system may be highly dependent on communication and single points of failures, as information may be processed, and control signals determined, at the central computing system.

A distributed control system can use controllers distributed throughout the power distribution system. Responsibility for information collection and generation of control actions can be shared among these multiple controllers. By using multiple controllers, the resilience of the power distribution system can be improved. However, control actions can require access to detailed information about the overall power distribution system. Consequently, all controllers may require access to such information. Furthermore, in some implementations, all controllers may need to be capable of controlling the overall power distribution system. As it was the case for the centralized control, the distributed control may be unsuitable for managing distributed generation or storage resources requiring rapid management (e.g., on a sub-second time scale), due to communications latency and the control algorithm execution time. Furthermore, design of a distributed control system may be difficult, as the control system must coordinate control actions amongst the different controllers and provide rules for recovering from a controller failure.

Decentralized control systems can permit elements of the power system to make decisions related to their own actions for the benefit of the overall system. The response of the overall power system may then be the aggregation of all the individual responses. Decentralized control can be effective in situations where local node actions are enough to achieve the global performance goals. However, with the proliferation of distributed small-scale solar photovoltaic generation, the decentralized response of these small resources may be insufficient to ensure the reliability and economic viability of the overall power system. Furthermore, the decentralized control systems can suffer from coordination failures: the responses of the distributed resource may need to be commanded based on conditions that are generally unknown to decentralized control nodes. To solve this limitation, some decentralized control schemes assign a leader to the system. The leader has access to additional information related to the complete system and provide operating rules and/or guidance to the rest of the nodes. However, the more responsibility assigned to the leader, the more the decentralized control system approximates a centralized control system, with all the disadvantages thereof.

Power distribution systems can experience faults, which can harm people, animals, equipment, communities, and ecosystems. During a ground fault, a power distribution system may discharge substantial amounts of power (e.g., high currents or at high voltages) through the fault to ground. A person or animal in the path to ground may experience significant injury or death, while equipment in the path to ground may be damaged. An over-voltage or under-voltage fault may occur when the power distribution system operates outside its specified voltage range. Such faults may result in damage to (or intended behavior by) equipment designed to operate within the specified voltage range.

Detecting faults in a power distribution system can be difficult. A power distribution system may use power, current or voltage measurements obtained by a limited number of sensors to discriminate between faults and normal operations. In some power distribution systems, however, measurement noise or a similarity between measurements during a fault and measurements during normal operation may prevent or delay fault detection. Unfortunately, depending on the architecture of the power distribution system, reductions in measurement noise or a greater differentiation between power, current or voltage values during a fault and power, current or voltage values during normal operation may be impractical or impossible.

A distributed power system can include multiple separate, independently controlled power systems. Each of these power systems can include a controller that manages the generation and consumption of power within that power system, as well as the exchange of power with other power systems. The capabilities of the controller can be improved by enabling the controller to communicate with external computing devices. Such communications can be used to upgrade the controller with new functionality or configurations, provide instructions for coordinating the operations of the controller with controllers of other power systems, and provide information the controller can use to improve management of the power system. However, such communications also provide a route for compromising or corrupting the operations of the power system. Furthermore, even without the intervention of malicious actors, the controller may fail or malfunction, potentially damaging the components of the power system and potentially destabilizing the distributed power system.

### SUMMARY

The disclosed embodiments include systems, methods, and devices for management of power distribution system. The disclosed embodiments can permit decentralized control of a power distribution system including multiple nodes that can adapt to changes in power distribution and use within each node.

The disclosed embodiments include a smart interface controller for managing power transfer in a distributed power transmission system. The smart interface controller can include at least one processor and at least one memory storing instructions. When executed by the at least one processor, the instructions can cause the smart interface controller to perform operations. The operations can include receiving, from a first node including an energy storage component, a first power transfer request for the first node. The first power transfer request can indicate a requested power transfer value based at least in part on a status of the energy storage component. The operations can further include receiving, from a second node, a second power transfer request for the second node. The operations can further include determining a power transfer value between the first node and the second node based at least in part on the first power transfer request and the second power transfer request. The operations can further include providing, to a power converter, instructions to transfer power between the first node and the second node according to the determined power transfer value.

The disclosed embodiments include a power distribution system. The power distribution system can include a first node, second nodes, and at least one smart interface controller. The first node can include an energy storage component and can be configured to repeatedly determine first power transfer requests based at least in part on a status of the energy storage component. The second nodes can include respective energy storage components. The second nodes can be configured to repeatedly determine second power transfer requests based at least in part on statuses of the respective energy storage components. The at least one smart interface controller can be configured to transfer power between the first node and the second nodes, and can be configured to repeatedly update values of the power transfer based on a present first power transfer request and a present second power transfer request.

The disclosed embodiments can include a power distribution system. The power distribution system can include a first node and second nodes. The first node configured to maintain a status of a first energy storage component within a first range, at least in part by providing a first power transfer request to at least one smart interface controller. The second nodes can be configured to maintain statuses of second energy storage components within respective second ranges, at least in part by providing respective second power transfer requests to the at least one smart interface controller. The at least one smart interface controller can be configured to determine power transfer values between the first node and the respective second nodes based on at least in part on the first power transfer request and the respective second power transfer requests.

The disclosed embodiments can include a community DC power distribution system. The community DC power distribution system can include a community node including a voltage source, a first switch, and a second switch, and a power distribution loop. The power distribution loop can include first power distribution lines (i) configured to be grounded through respective resistances of between 1 kOhm and 100 kOhm, (ii) configured to have a voltage difference of at least 380V, and (iii) electrically connected to the first switch, first local nodes, and a third switch. The power distribution loop can include second power distribution lines (i) configured to be grounded through respective resistances of between 1 kOhm and 100 kOhm, (ii) configured to have a voltage difference of at least 380V, and (iii) electrically connected to the second switch, second local nodes, and the third switch. The community node can be configured to provide power to the first local nodes via the first power distribution lines and the first switch when the first switch is in a closed state. The community node can be configured to provide power to the second local nodes via the second power distribution lines and the second switch when the second switch is in a closed state.

The disclosed embodiments include a backup controller. The backup controller can be configured to control a power system when abnormal operations are detected. In some embodiments, the backup controller can be configured to assume control from a primary controller in response to detecting the abnormal operations.

The disclosed embodiments include a multi-mode management system. This system can include a first controller configured to control a power system and a second controller. The second controller can be configured with multiple modes. In a first mode, the second controller can estimate a state of the power system by monitoring communications between the first controller and the power system, and in response to satisfaction of a first condition, switch to a second mode. In the second mode, the second controller can disable communication between the first controller and the power system and control the power system based on the estimated state of the power system.

The disclosed embodiments include a management system. The management system can include a first controller and a second controller. The first controller can be configured to control a power system using an internal communication network, the first controller configurable through an external communication network. The second controller can be configured to monitor communications between the first controller and the power system on the internal communication network. In a first mode, the second controller can be configured to permit communication between the first controller and the power system and, in response to satisfaction of a first condition, enter a second mode. In the second mode, the second controller can be configured to disable communication between the first controller and the power system and control the power system using the internal communication network.

The disclosed embodiments include a power system. The power system can include a backup controller. The backup controller can be configured to in a first mode, forward communications received from a storage component of the power system to a primary controller. In a second mode, the backup controller can be configured to determine a control value based on at least one of: a power transfer rate of the storage component; a state of charge of the storage component; or a power boundary value. The backup controller can further be configured to determine, based on the control value, a value of power transfer between an external power bus connected to an external power source and an internal power bus connected to the storage component. The backup controller can further be configured to provide, to an interface device that controls power transfer between the external power bus and the internal power bus, a request to transfer power between the external power bus and the internal power bus based on the power transfer value.

It is to be understood that both the foregoing general description and the following detailed description are exemplary and explanatory only and are not restrictive of the disclosed embodiments, as claimed.

### BRIEF DESCRIPTION OF THE DRAWINGS

The drawings are not necessarily to scale or exhaustive. Instead, emphasis is generally placed upon illustrating the principles of the embodiments described herein. The accompanying drawings, which are incorporated in and constitute a part of this specification, illustrate several embodiments consistent with the disclosure and, together with the description, serve to explain the principles of the disclosure. In the drawings:

FIG. 1 depicts an exemplary system for power distribution, consistent with disclosed embodiments.

FIG. 2 depicts an exemplary method for distributing power between components of a power distribution system, consistent with disclosed embodiments.

FIG. 3 depicts an exemplary method for determining power transfer between components of a power distribution system, consistent with disclosed embodiments.

FIG. 4 depicts an exemplary DC power distribution system, consistent with disclosed embodiments.

FIGS. 5A, 5B, and 5C depicts exemplary DC power distribution systems in various configurations, consistent with disclosed embodiments.

FIGS. 6A and 6B illustrates exemplary community DC power distribution systems having a clover leaf topology, consistent with disclosed embodiments.

FIG. 7 depicts exemplary topologies of DC power distribution systems, consistent with disclosed embodiments.

FIG. 8 depicts exemplary processes for handling faults in a community DC power distribution system, consistent with disclosed embodiments.

FIG. 9 depicts an exemplary community node distributor for applying a voltage source to power distribution lines, consistent with disclosed embodiments.

FIG. 10 depicts an exemplary system for enabling power exchange between community DC power distribution systems, consistent with disclosed embodiments.

FIG. 11 depicts an exemplary power system and controllers, consistent with disclosed embodiments.

FIG. 12 depicts an exemplary method for switching control of a power system between controllers, consistent with disclosed embodiments.

FIG. 13 depicts an exemplary method for controlling a power system, consistent with disclosed embodiments.

FIG. 14 depicts an exemplary dependence of a power control factor on power transfer, consistent with disclosed embodiments.

FIG. 15 depicts an exemplary dependence of a state of charge value on a state of charge of storage components of a power system, consistent with disclosed embodiments.

FIG. 16 depicts an exemplary dependence of a power boundary value on information encoded into an external power supply, consistent with disclosed embodiments.

### DETAILED DESCRIPTION

Reference will now be made in detail to exemplary embodiments, discussed with regards to the accompanying drawings. In some instances, the same reference numbers will be used throughout the drawings and the following description to refer to the same or like parts. Unless otherwise defined, technical and/or scientific terms have the meaning commonly understood by one of ordinary skill in the art. The disclosed embodiments are described in sufficient detail to enable those skilled in the art to practice the disclosed embodiments. It is to be understood that other embodiments may be utilized and that changes may be made without departing from the scope of the disclosed embodiments. For example, unless otherwise indicated, method steps disclosed in the figures can be rearranged, combined, or divided without departing from the envisioned embodiments Similarly, additional steps may be added, or steps may be removed without departing from the envisioned embodiments. Thus the materials, methods, and examples are illustrative only and are not intended to be necessarily limiting.

The disclosed embodiments include power distribution systems. Such power distribution systems can implement one or more of the topologies, fault detection and remediation methods, and controllers specified herein. For example, a community DC power distribution system as described in the “Exemplary Power Distribution Topologies” section of this specification can incorporate a controller or decentralized control architecture as described in the “Decentralized Control of Power Distribution” section of this specification. As an additional example, a controller or decentralized control architecture as described in the “Decentralized Control of Power Distribution” section of this specification can implement a second controller or backup controller architecture as described in the “Backup Control for Power System Management” section of this specification. As an additional example, a community DC power distribution system as described in the “Exemplary Power Distribution Topologies” section of this specification can incorporate nodes implementing second controllers or backup controllers as described in the “Backup Control for Power System Management” section of this specification. As a further example, a community DC power distribution system as described in the “Exemplary Power Distribution Topologies” section of this specification can incorporate a controller or decentralized control architecture as described in the “Decentralized Control of Power Distribution” section of this specification and the second controller or backup controller architecture as described in the “Backup Control for Power System Management” section of this specification. A non-exclusive list of potential embodiments combining the topologies, fault detection and remediation methods, and controllers specified herein is provide in clauses 101 to 104, below. As would be appreciated by those of skill in the art, the improvements described in each of these sections can also be implemented independently of the improvements listed in other sections.

Decentralized Control of Power Distribution

The disclosed embodiments can enable decentralized control of a power distribution system including multiple nodes. Each node can execute its own energy management and optimization (e.g., independently of the rest of the system). This optimization can produce a requested power transfer value between that node and one or more connected nodes. Furthermore, these connected nodes can execute their own energy management and optimization that results in their own requested power transfer values. Smart interface controllers can receive requested power transfer values from one or more pairs of connected nodes. These controllers can then determine power transfer values for each pair of nodes based at least in part on the requested energy transfer values. In this manner, the overall system can adapt to changes in power distribution and use within each node.

As a non-limiting example, a community node can be connected to multiple local nodes through multiple smart interface controllers. A local node can provide a request for an increase in power transfer from the community node to a smart interface controller connecting the local node to the community node. The smart interface controller can increase the power transferred from the community node. The community node can detect this increase in transferred power and can respond by providing requests to reduce power transfer to the smart interface controllers connected to the community node. The smart interface controllers can reduce the power transferred to these local nodes. Meanwhile, the community node can begin increasing power generation to reflect the overall increase in power consumption. In some embodiments, throughout this process, each node may only be aware of its own status and the power transferred by the smart interface controller. Thus the overall system can be managed without requiring the nodes to share detailed or specific information about their statuses.

As an additional non-limiting example, two separate distributed networks can be connected by a smart interface controller. The smart interface controller can receive indications of power needs from both controllers for both distributed networks. Such indications can include a requested power transfer value or a pattern indicating requested future power transfer values in addition to the presently requested power transfer value. Such a pattern can be or include a set of power transfer values. Such a pattern can further include or be associated with an express or implicit timing for each of the set of power transfer values. The smart interface controller can execute an optimization algorithm to decide how much power is exchanged at the present and future time. For example, the smart interface controller can determine power transfer value or a pattern of power transfer values. As can be appreciated from the foregoing, neither of the controllers for the distributed system requires information about the other system as the power transfer may only depend on the general needs (e.g. requested power transfer values) expressed by both systems.

The disclosed embodiments provide technical improvements in management of power distribution systems. The disclosed embodiments can be used in power distribution systems with large penetration of distributed generation and distributed storage, where the management of these systems in a centralized, distributed, or decentralized methods faces roadblocks and limitations. The disclosed embodiments can further be used to interconnect multiple community distributed systems such as two separate microgrids, each with its own power generation and usage characteristics. By adding a smart interface controller between the two systems, energy can be exchanged amongst them in a flexible way that prioritizes the internal energy management while addressing some needs from the other system, but with minimum exchange of information amongst the two systems. The disclosed embodiments can further be used for plug-and-play nesting of multiple microgrids as well as the integration of local small microgrids with larger community resources requiring low engineering and configuration effort.

As an additional benefit, the disclosed embodiments can improve security and reduce implementation costs by reducing the exchange of information between nodes. Power can flow between nodes without sharing information between these nodes. Nodes may provide limited amounts of information to smart interface controllers at specific times, enabling easy detection or screening of anomalous messages. In this manner the disclosed embodiments can reduce or prevent cyberattacks. Furthermore, as smart interface controllers may receive limited information at specific times, these smart interface controllers may have limited communication bandwidth and processing power requirements. Accordingly, the smart interface controllers can be implemented using low-cost components. In some embodiments, the smart interface controller can be embedded in a power converter that regulates power transfer between two nodes.

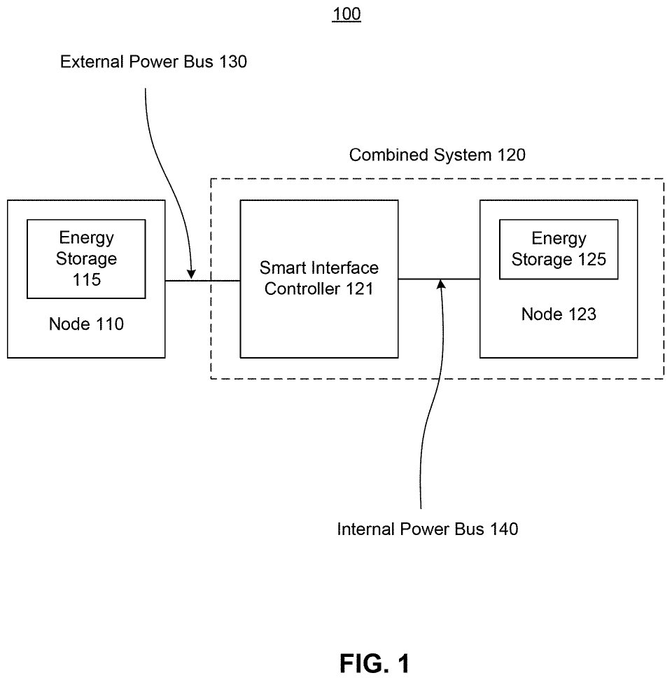

FIG. 1 depicts a system 100 for power distribution, consistent with disclosed embodiments. System 100 can include multiple nodes (e.g., community node 110 and local node 123 of combined system 120) connected by power distribution buses (e.g., external bus 130 and internal bus 140) through smart interface controllers (e.g., smart interface controller 121) to enable decentralized control of power distribution, while minimizing the information communicated between nodes. By minimizing the information communicated, according to disclosed embodiments, system 100 can enhance security while still providing flexibility and resilience in response to changes in power generation and usage. In this manner, system 100 can support enhanced flexibility, resilience, and security, as compared to conventional systems.

In some embodiments, the nodes of system 100 can be hierarchically arranged. Nodes with more generation or storage capabilities may provide power to nodes with lesser generation or storage capabilities. As a non-limiting example, a community including multiple residences can have a node associated with the community and a node associated with each of the residences. The node associated with the community can include a generation source (e.g., a coal-fired powerplant) and a utility-scale energy storage component (e.g., megawatt-hour capacity batteries). The nodes associated with the residences may or may not include generation components (e.g., solar panels) and may have smaller energy storage components (e.g., kilowatt-hour capacity batteries). In this example, the community node may typically provide power to each of the residential nodes. But the amount of power provided may vary between residential nodes, and under some circumstances the direction of power transfer may reverse, with a residential node providing power to the community node (e.g., a residential node with substantial solar generation capabilities can provide power to the community node on a sunny day).

Community node 110 can include an electrical power grid, energy storage component 115, and a controller 117 (not shown in FIG. 1). In some embodiments, a single device can include, or provide the functionality of, energy storage component 115 and controller 117. In various embodiments, separate devices can include, or provide the functionality of, energy storage component 115 and controller 117. In some embodiment, the controller for community node 110 can be implemented as, or as part of, a smart interface controller (e.g. a smart interface controller similar to smart interface controller 121). In various embodiments, the controller for community node 110 can be separate from a smart interface controller. In such embodiments, the controller for community node 110 can be configured to manage community node 110 and determine requests for power transfer between nodes, while a smart interface controller can be configured to receive requests from multiple nodes and determine the amount of power to transfer based at least in part on the received requests. Community node 110 can include generation sources that provide power and loads that consume power. Community node 110 can be connected to combined system 120 through external power bus 130. Community node 110 can be configured to exchange power with combined system 120 using external power bus 130.

The electrical power grid can be configured to provide electrical current at a voltage amplitude (or within a voltage amplitude range). The electrical power grid can be an alternating current power grid or a direct current power grid. The disclosed embodiments are not limited to any particular topology or implementation of this power grid. In some embodiments, the electrical power grid in community node 110 can be or include external power bus 130.

Energy storage component 115 can be configured to automatically provide or store power in order to maintain the electric power grid at a voltage amplitude or within a voltage amplitude range (e.g., voltage amplitude can be within −20% and +10% of a nominal value). In some embodiments, energy storage component 115 can be configured to address changes in power generation occurring on a timescale of less than a second, less than a minute, or less than an hour.

Energy storage component 115 can include at least one of an electrical (e.g. capacitive, or the like), electrochemical (e.g., battery or the like), mechanical (e.g., flywheel, compressed or liquid air, or the like), hydroelectric (e.g., pumped storage or the like), or similar energy storage system. In some embodiments, the storage component can be configured to sink or source direct current at a voltage. In some embodiments, energy storage component 115 can be directly connected to the power grid. For example, the storage device can be one or more batteries having terminals connected directly to the power grid. In such embodiments, a voltage of the electrical power grid can be automatically maintained at a setpoint determined by the energy storage component 115. For example, when the terminals of the one or more batteries are directly connected to the electrical power grid, the voltage of the electrical power grid can automatically depend on a state of charge of the battery, without requiring additional hardware or software. In various embodiments, the storage component can be indirectly connected to the power grid. For example, a converter (such as a DC/DC convertor or power inverter) can be placed between the energy storage component and the power grid. The converter can be configured to sink or source power from the electrical power grid as necessary to maintain a voltage of the electrical power grid at a setpoint or within a range (e.g., a predetermined setpoint or range).

The controller of community node 110 (e.g., controller 117) can be configured to manage community node 110 to maintain the electrical power grid at a voltage amplitude or within a voltage amplitude range. In some embodiments, the controller can be configured to address variations in power generation and demand on a timescale of a minute to an hour, or an hour to a day, or multiple days. In some embodiments, such management can be performed to reduce operating costs of community node 110 or to extend the lifetime of one or more components of the community node (e.g., energy storage component 115).

The controller of community node 110 (e.g., controller 117) can be configured to manage the community node 110 based on management information concerning or affecting the past, present, or future status of community node 110. In some embodiments, the controller can be configured to receive this information using one or more communications networks (e.g., a local area network, wide area network, mobile network, or the like). For example, the controller can be connected to other components of community node 110 over a local area network and to external devices over a mobile network or the interne.

The management information can include status information concerning components of community node 110. In some embodiments, the status information can concern energy storage component 115. Such information for the storage component can include indications of the amount of energy stored and the performance of energy storage component 115. For example, when energy storage component 115 is a battery, the status information can include a state of charge of the battery (e.g. 50% charged or the like), a power output of the battery (e.g., discharging at 120 watts or charging at 60 watts, or the like), or a temperature of the battery (e.g., 30 degrees Celsius, 60 degrees Celsius, or the like). In some embodiments, the status information can concern a generation component. Status information concerning a generation component can indicate the power generated by the component (e.g., the power, the current provided at an express or implied voltage, or the like). In some embodiments, the status information can concern a load. Status information concerning a load can include the power consumed by the load (e.g., the power, the current drawn at an express or implied voltage, or the like).

The management information can include information obtained by the controller of community node 110 (e.g., controller 117). For example, the controller can be configured to track historical power generation and usage by community node 110 or by the components of community node 110. As an additional example, the controller can be configured to track power transfers with other nodes. For example, the controller can be configured to detect a power transfer value between community node 110 and another node. This detected power transfer value can be used, at least in part, to determine a subsequent power transfer request. In some embodiments, historical power generation and usage data or power transfer values can be tracked by another system and provided to the controller. For example, smart interface controller 121 can be configured to provide an indication of a power transfer value between community node 110 and local node 123 to either or both nodes.

The management information can include information received from sources external to community node 110. For example, the received information can include weather forecasts, load forecasts, ambient temperatures, maintenance schedules, fuel costs, electricity prices, or the like. In some embodiments, smart interface controller 121 can be configured to provide an indication of the current power transfer value between community node 110 and local node 123. The received information can include such indications.

The controller of community node 110 (e.g., controller 117) can be configured to manage community node 110 based on the management information. In some embodiments, the controller can be configured to determine a historical net power usage, present net power usage, or predicted net power usage for community node 110 based on the management information. The historical net power usage, present net power usage, or predicted net power usage can be by devices connected to the electrical power grid of community node 110. For example, community node 110 can use tracked historical power generation and usage to determine historical net power usage. As an additional example, community node 110 can use a current discharge rate of the storage component or the current power transfer value (e.g., received from smart interface controller 121 or measured on external power bus 130) to determine current net power usage. As a further example, community node 110 can use a weather report or historical net power usage information (e.g., determined from historical usage generation and historical usage information) to determine predicted net power usage for the community node. To continue this example, the controller can be configured to determine historical net power usage during past periods with weather similar to the forecasted weather.

The controller of community node 110 (e.g., controller 117) can be configured to manage community node 110 to maintain the status of energy storage component 115 at parameter values or within parameter ranges (e.g., predetermined parameters or parameter ranges) using the historical net power usage, present net power usage, or predicted net power usage. For example, the controller can be configured to use a current net power usage and predicted net power usage to predict a future status of energy storage component 115 (e.g., when energy storage component 115 is a battery, a future state of charge of the battery, future discharge rate of the battery, or future temperature of the battery). When the predicted status of energy storage component 115 falls outside a parameter range (e.g., the battery is predicted to become overly charged or discharged, charge or discharge at an excessive rate, or overheat) the controller can manage community node 110 to maintain the status of energy storage component 115 within the parameter range.

The controller of community node 110 (e.g., controller 117) can be configured to manage community node 110 by modifying power generation, power usage, or power storage within community node 110. The controller can modify power generation by adding or removing power generation sources to or from the power grid. For example, the controller can provide instructions to configure renewable power generation sources such as wind turbine or solar panels to contribute power to the power grid. As an additional example, the controller can provide instructions to start or stop generators connected to the power grid, such as gas peaking plants or other power plants. The controller can be configured to manage local power use by providing instructions to adjust power consumption by devices connected to the electrical power grid of community node 110. For example, the controller can modify power usage by providing instructions to shed loads or reschedule the actions of devices connected to the electrical power grid of community node 110. For example, the controller can provide instructions to turn off or reschedule operation of an air conditioning unit or turn off external lights on a dwelling. In some embodiments, the power generation components or loads can automatically implement the instructions provided by the controller. In various embodiments, the instructions can be implemented at least partially manually.

The controller of community node 110 (e.g., controller 117) can manage community node 110 by requesting power transfers with other nodes. For example, community node 110 can be configured to provide a request to transfer power between community node 110 and another node. In some embodiments, the request can be provided to a smart interface controller (e.g., smart interface controller 121). The smart interface controller can be connected to community node 110 by a power bus (e.g., external power bus 130) and connected to the other node by another power bus (e.g., internal power bus 140). In other embodiments not shown in FIG. 1, the smart interface controller can be part of community node 110, or part of controller 117. In such embodiments, the request may be handled within community node 110 or within controller 117.

The power transfer request can indicate one or more requested power transfer value. In various embodiments, the power transfer request can include a pattern indicating requested future power transfer values in addition to the presently requested power transfer value. Such a pattern can include a set of requested power transfer values. In some embodiments, each requested power transfer value can have a magnitude (e.g., a power transfer amount) and direction (e.g., transferring power to community node 110 or from community node 110). When the request includes a pattern of requested power transfer values, each requested power transfer value can be associated with a time. For example, the time for each requested power transfer value could be explicit or implicit. Examples of expressly indicating times include, but are not limited to, providing tuples of power transfer values and times, or providing at least one of a start time or a time increment. Examples of implicitly indicating times include, but are not limited to, situations in which time values are associated with requested power transfer values according to a specification, default procedure, or other predetermined mechanism.

In some embodiments, the power transfer request can include authentication or authorization information. Such information can enable a node (e.g., community node 110 or local node 123) to establish an identity with a smart interface controller (e.g., smart interface controller 121) and can allow the smart interface controller to place authorization restrictions on power transfer requests, or on requested power transfer value.

The controller of community node 110 (e.g., controller 117) can be configured to repeatedly request power transfers with other nodes, consistent with disclosed embodiments. The controller can manage community node 110 through adjustment of the requested power transfer value included in each of the repeated requests. In various embodiments, the controller can be configured to request power transfers according to a schedule, or periodically (e.g., every 10 to 100,000 seconds). In some embodiments, the controller can be configured to request power transfers irregularly (e.g., as needed to maintain a status of energy storage component 115 within a parameter range). In such embodiments, the controller can manage community node 110 through adjustment of the timing of the request as an alternative to, or in addition to, adjustment of the requested power transfer value indicated in the request.

Community node 110 can be configured to provide the power transfer request to multiple smart interface controllers, consistent with disclosed embodiments. For example, community node 110 can be connected through smart interface controllers to multiple local nodes, or to another community node. Community node 110 can be configured to provide the power transfer request to the smart interface controllers for each of these connected nodes. The power transfer requests may or may not be provided simultaneously to the smart interface controllers for each of the connected nodes.

The controller of community node 110 (e.g., controller 117) can determine the requested power transfer value of a request based at least in part on the management information. In some embodiments, the value of the request can be determined based on the status of the components of community node 110. For example, the controller can request power from the other nodes when energy storage component 115 of community node 110 satisfies a minimum-power criterion (e.g., when the storage component is a battery, the minimum-power criterion can be a minimum state of charge threshold) or maximum-discharge criterion (e.g., when the storage component is a battery, the maximum-discharge criterion can be a maximum discharge threshold for the battery). As an additional example, the controller can request to provide power to the other nodes when energy storage component 115 satisfies a maximum-power criterion. In various embodiments, the request can be determined based on a historical net power usage, present net power usage, or predicted net power usage for community node 110 (e.g., based on a historical net power usage, present net power usage, or predicted net power usage by devices connected to the electrical grid of community node 110). In some embodiments the request can be determined based on a function (e.g., the minimum, maximum, mean, a value a standard deviation above the mean, the 95% percentile, or another suitable function) over a predetermined period of time, of the historical net power usage, present net power usage, or predicted net power usage (e.g., the average net power usage over the period of time). In some instances, the predetermined period of time can be greater than an hour and less than a month, or longer. For example, the request can be based on the historical net power usage of devices connected to the electrical grid of community node 110 over the past month, or past three months. For example, the controller can request power from the other nodes now (or to request to provide power to the other nodes now), in anticipation of a shortfall (or surplus), when energy storage component 115 is predicted to satisfy the minimum-power criterion (or maximum-power criterion) at a future time, based on the predicted net power usage. As an additional example, when energy storage component 115 is a battery and the battery is predicted to overheat, based on the predicted net power usage, the controller can request power from the other nodes now, to reduce a discharge rate of the battery (thereby allowing the battery temperature to cool). The disclosed embodiments are not limited to a particular formula for determining the value of the request based on the management information.

External bus 130 can be configured to transfer power between the community node 110 and the combined system 120. External bus 130 can be configured to transfer direct current or alternating current and is not limited to a particular voltage amplitude (or frequency in embodiments using alternating current). In some embodiments, external power bus 130 can be, or be part of, the electrical power grid of community node 110.

In some embodiments, smart interface controllers can be included in nodes of system 100. For example, as depicted in FIG. 1, combined system 120 can include local node 123 and smart interface controller 121 (alternatively, a combined system could include community node 110 and smart controller 121, implemented as described herein). Similar to community node 110, local node 123 can include a controller 127 (not shown in FIG. 1), an energy storage component (e.g., energy storage component 125) and an electrical power grid. In some embodiment, the controller for local node 123 can be implemented as, or as part of, smart interface controller smart interface controller 121. In various embodiments, controller 127 can be separate from smart interface controller 121. In such embodiments, controller 127 can be configured to manage local node 123 and determine requests for power transfer between nodes, smart interface controller 121 can be configured to receive requests from multiple nodes (e.g., community node 110 and local node 123) and determine the amount of power to transfer between these nodes based at least in part on the received requests. In some embodiments, a single device can include, or provide the functionality of, at least two of controller 127, energy storage component 125, and smart interface controller 121. In various embodiments, smart interface controller 121 can be separate from local node 123 (e.g., smart interface controller 121 can be implemented on a device separate from the device(s) implementing energy storage component 125 and controller 127). When a smart interface controller is included in a node, communications described herein as being sent to the smart interface controller may, in some embodiments, be sent to the node including the smart interface controller. This node may then act on the received communications, for example by forwarding them to the smart interface controller or communicating with the smart interface controller in response to the received communications.

The electrical power grid can be configured to provide electrical current at a voltage amplitude (or within a voltage amplitude range). The electrical power grid can be an alternating current power grid or a direct current power grid. The disclosed embodiments are not limited to any particular topology or implementation of this power grid. In some embodiments, the electrical power grid in local node 123 can be or include internal power bus 140.

Energy storage component 125 can be similar in construction and operation to energy storage component 115. Energy storage component 125 can be configured to automatically provide or store power in order to maintain the electric power grid at a voltage amplitude or within a voltage amplitude range (e.g., voltage amplitude can be within −20% and +10% of a nominal value). In some embodiments, energy storage component 125 can be configured to address changes in power generation occurring on a timescale of less than a second, less than a minute, or less than an hour. Energy storage component 125 can include at least one of an electrical, electrochemical, mechanical, hydroelectric, or similar energy storage system. In some embodiments, energy storage component 125 can be directly or indirectly connected to the electrical power grid.

The controller of local node 123 (e.g., controller 127) can be configured to operate similarly to the controller of community node 110 (e.g., controller 117). The controller of local node 123 can be configured to manage local node 123 to maintain the electrical power grid at a voltage amplitude or within a voltage amplitude range. In some embodiments, the controller of local node 123 can be configured to address variations in power generation and demand on a timescale of a minute to an hour, or an hour to a day or multiple days. In some embodiments, such management can be performed to reduce operating costs of local node 123 or to extend the lifetime of one or more components of the community node (e.g., energy storage component 125).

Similar to the controller of community node 110 (e.g., controller 117), the controller of local node 123 (e.g., controller 127) can be configured to manage local node 123 based on management information concerning or affecting the past, present, or future status of local node 123. The management information can include status information concerning components of local node 123, such as energy storage component 125. The management information can include information generated by the controller of local node 123, such as tracked power generation and usage or transfers of power from other nodes. The management information can include information received from sources external to local node 123, such as smart interface controller 121.

Similar to the controller of community node 110 (e.g., controller 117), the controller of local node 123 (e.g., controller 127) can be configured to manage local node 123 to maintain the status of energy storage component 125 at a parameter value or within a parameter range (e.g., predetermined parameter values or predetermined parameter ranges). This controller can manage local node 123 using historical net power usage, present net power usage, or predicted net power usage determined from the management information. Similar to the controller of community node 110, the controller of local node 123 can be configured to manage local node 123 by modifying power generation, power usage, or power storage within local node 123; or by requesting power transfers with other nodes. The controller of local node 123 can be configured to manage local power use by providing instructions to adjust power consumption by devices connected to the electrical power grid of local node 123. For example, the controller of local node 123 can modify power usage by providing instructions to automatically, or at least partially manually, shed loads, or reschedule the actions of devices connected to the electrical power grid of local node 123.

The controller of local node 123 (e.g., controller 127) can be configured to provide power transfer requests to smart interface controller 121. The power transfer requests can indicate a requested power transfer value. The requested power transfer value can have a magnitude (e.g., a power transfer amount) and direction (e.g., transferring power to local node 123 or from local node 123). In some embodiments, the controller can be configured to repeatedly request power transfers with other nodes. In such embodiments, the controller can manage local node 123 through adjustment of the requested power transfer value included in each of the repeated requests. In various embodiments, the controller can be configured to request power transfers according to a schedule, or periodically (e.g., every 10 to 100,000 seconds). In some embodiments, the controller can be configured to request power transfers irregularly (e.g., as needed to maintain a status of energy storage component 125 within a parameter range). In such embodiments, the controller can manage local node 123 through adjustment of the timing of the request as an alternative to, or in addition to, adjustment of the requested power transfer value indicated in the request.

The controller of local node 123 (e.g., controller 127) can determine the requested power transfer value of a request based at least in part on the management information. In some embodiments, the requested power transfer value can be determined based on the status of the components of local node 123. In various embodiments, the request can be determined based on a historical net power usage, present net power usage, or predicted net power usage for local node 123 (e.g., based on a historical net power usage, present net power usage, or predicted net power usage by devices connected to the electrical grid of local node 123). In some embodiments the request can be determined based on a historical net power usage, present net power usage, or predicted net power usage over a predetermined period of time. In some instances, the predetermined period of time can be greater than an hour and less than a month, or longer. The disclosed embodiments are not limited to a particular formula for determining the value of the request based on the management information.

Smart interface controller 121 can be configured to receive power transfer requests from community node 110 and local node 123. Based on the power transfer requests, smart interface controller 121 can be configured to determine one or more power transfer values between community node 110 and local node 123.

In some embodiments, smart interface controller 121 can be configured to determine a pattern of power transfer values. The pattern can include a number of power transfer values associated with times, as described herein. Smart interface controller 121 can determine such a pattern using a power transfer value or a pattern of desired power transfer values received from at least one of community node 110 and local node 123. For example, smart interface controller 121 can receive patterns of requested power transfer values from both of community node 110 and local node 123 and determine a pattern of power transfer values based on these received patterns. The received power transfer values can differ from each other and from the determined pattern in number of power transfer values and times associated with the power transfer values. For example, community node 110 can provide a pattern of four power transfer values, one associated with the present time, another associated with a time 6 hours in the future, another associated with a time 12 hours in the future, and another associated with a time 18 hours in the future. Local node 123 can provide a pattern of 24 power transfer values, one associated with the present time and one associated with each of the following 23 hours. Smart interface controller 121 can be configured to determine, based on these two patterns, a pattern including 12 power transfer values, one associated with the present time and one associated with each two-hour increment of the following 22 hours.

In various embodiments, smart interface controller 121 can be configured to recalculate a pattern in response to receipt of a new power transfer request from one (or in some embodiments both) of community node 110 and local node 123. In various embodiments, smart interface controller 121 can be configured to recalculate such a pattern only when the current pattern has been implemented (e.g., while or after power is transferred according to the last power transfer value in a pattern).

In some embodiments, smart interface controller 121 can be configured to determine a pattern of power transfer values that reduces the changes in power flow over the implementation time of the pattern. For example, when community node 123 requests to provide little power during a first time interval, but greater power during a second, later time interval, smart interface controller 121 can determine that a moderate level of power should be provided during both power intervals. As could be appreciated by one of skill in the art, the disclosed embodiments are not intended to be limited to embodiments that determine power transfer patterns according to this heuristic.

In various embodiments, smart interface controller 121 can be configured to determine a power transfer value. In some embodiments, this power transfer value may not be associated with any time. Instead, smart interface controller 121 can be configured to transfer power according to this power transfer value until it calculates another power transfer value or a pattern. The power transfer value can be determined using a power transfer value or a pattern of desired power transfer values received from at least one of community node 110 and local node 123. For example, smart interface controller 121 can determine a power transfer value using power transfer values received from both community node 110 and local node 123 (or a power transfer value and a pattern, or two patterns). An exemplary method of determining such power transfer values is disclosed herein.

In some embodiments, smart interface controller 121 can be configured to share the determined power transfer value or pattern with one or more of community node 110 and local node 123. By sharing the power transfer value or pattern, smart interface controller 121 can help the controller of the node (e.g., controller 117 or controller 127) optimize future power generation and use. In various embodiments, smart interface controller may not share the determined power transfer value or pattern. In such embodiments, the nodes can detect the determined power transfer value by monitoring the power sunk or sourced by the smart interface controller 121.

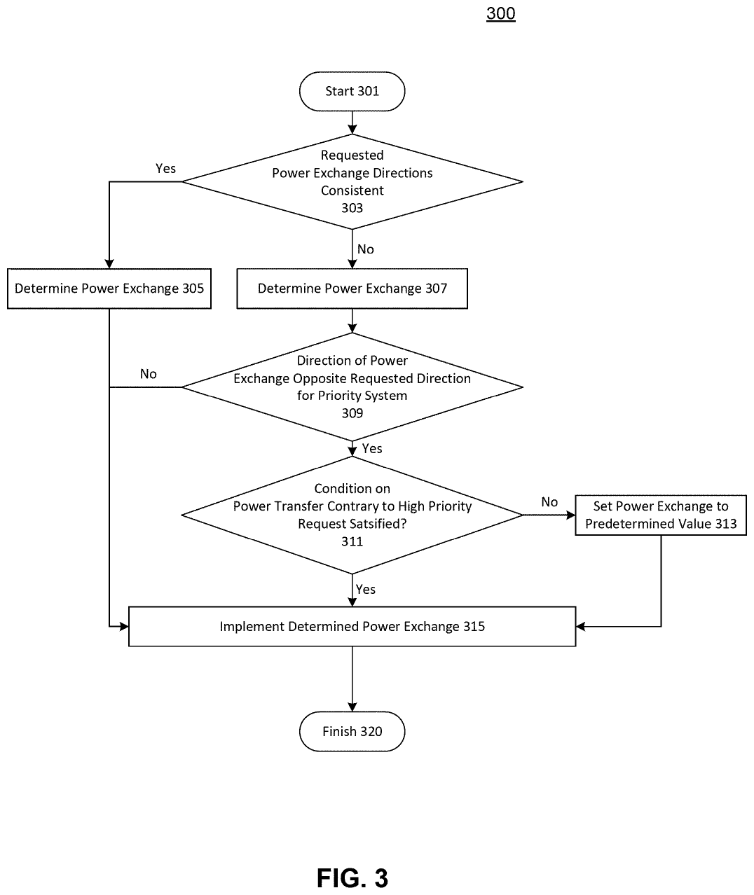

Smart interface controller 121 can be configured to repeatedly update power transfer values or patterns. In some embodiments, smart interface controller 121 can be configured to update power transfer values or patterns between community node 110 and local node 123 according to a schedule, or periodically (e.g., every 10 to 100,000 seconds). In various embodiments, smart interface controller 121 can be configured to update power transfer values or patterns between community node 110 and local node 123 in response to receipt of power transfer requests from community node 110 and local node 123. For example, smart interface controller 121 can be configured to update the power transfer value or pattern in response to receiving a new power transfer request from either community node 110 or local node 123. As an additional example, smart interface controller 121 can be configured to update the power transfer value or pattern after a new power transfer request has been received from both community node 110 and local node 123. FIG. 3 provides a non-limiting approach to determining a power transfer value based on the requested power transfer values included in the requests.

Smart interface controller 121 can be configured with parameters for use in determining a power transfer value or pattern, in addition to the received power transfer requests, in some embodiments. The parameters can include priorities associated with the nodes, according to some embodiments. For example, smart interface controller 121 can be configured to associate community node 110 with a lower priority than local node 123. In some embodiments, this association can reflect an assumption that community node 110 includes more generation and storage capabilities than local node 123. In various embodiments, this association can reflect an assumption that greater harm will arise from a power shortfall in the higher priority node (e.g., the higher priority node can be a microgrid for a hospital). In some embodiments, smart interface controller 121 can be configured to transfer power contrary to requests from lower priority nodes subject to first conditions and transfer power contrary to request from higher priority nodes subject to second conditions. The first conditions may be less restrictive than the second conditions. As a non-limiting example, in embodiments where the smart interface controller knows an amount of stored energy in each node, the first and second conditions may restrict power transfer away from a node when the node has less than a minimum amount of stored energy (e.g., when the storage component of the node includes one or more batteries, the state of charge of the batteries). But the first conditions may set a lower minimum amount of stored energy than the second conditions (e.g., reflecting an assumption that a lower priority node can add additional generation capacity). Likewise, the first and second conditions may restrict the magnitude of power transfer to or from a node. But the first conditions may set a higher maximum permissible magnitude than the second conditions.

The parameters can further include weights associated with the nodes, according to some embodiments. Smart interface controller 121 can be configured to use the weights to determine power transfer values or patterns based on the power requests. In some embodiments, when smart interface controller 121 receives incompatible power transfer requests (e.g., community node 110 and local node 123 both requesting power, or both requesting to provide power) smart interface controller 121 can determine the resulting power transfer value or pattern based on the weights. In some embodiments, the determined power transfer value or pattern can be the requested power transfer value or requested pattern of the node with the higher weight. In various embodiments, greater differences between weights can result in determined power transfer values more similar to the requested power transfer value or pattern of the node with the higher weight. As a non-limiting example, a determined power transfer value (or pattern) can be the weighted average of the requested power transfer values (or patterns) of the nodes.

The parameters can additionally include safety criteria, such as maximum power transfer criteria. For example, smart interface controller 121 can be configured to associate nodes with maximum power transfer values. The maximum power transfer values can depend on the node (e.g., a maximum power transfer value can be associated with node 123, which may be lower than the maximum power community node 110 can provide).

In some embodiments, smart interface controller 121 can be configured or reconfigured with the parameters, or values for the parameters, during production or after production of smart interface controller 121. Smart interface controller 121 can be configured or reconfigured with the parameters, or values for the parameters using a user interface of the smart interface controller 121 or remotely through a computing device communicatively connected to smart interface controller 121.

Smart interface controller 121 can be configured to provide instructions configuring a power converter to provide the determined power transfer value or pattern. The power converter can then transfer the determined magnitude of power in the determined direction between external power bus 130 and internal power bus 140. The power converter and the smart interface controller can be implemented in a single device or implemented in separate devices. The power converter can be or include an adjustable bi-directional current source.

The disclosed embodiments are not limited to the use of a single smart interface controller for each set of nodes. In some embodiments, a smart interface controller can be configured to provide instructions configuring multiple power converters, each connecting a pair of nodes. For example, community node 110 can be connected to multiple local nodes. Community node 110 can be connected to each of these local nodes through a power converter. In some embodiments, each power converter can be controlled by a different smart interface controller, while in other embodiments, two or more of these power converters can be controlled by the same smart interface controller.

Internal bus 140 can be configured to transfer power between smart interface controller 121 and local node 123. Internal bus 140 can be configured to transfer direct current or alternating current and is not limited to a particular voltage amplitude (or frequency in embodiments using alternating current). In some embodiments, internal power bus 140 can be, or be part of, the electrical power grid of local node 123.

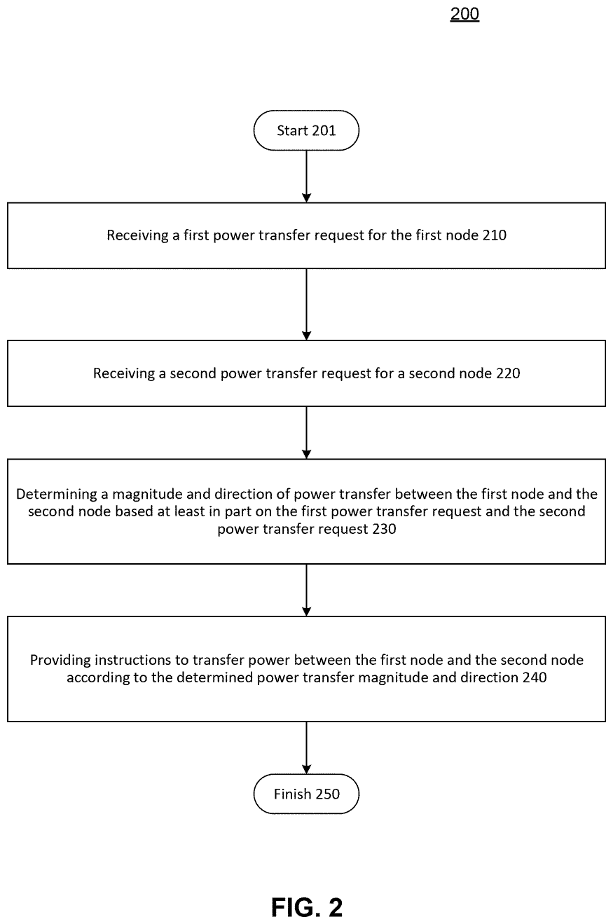

FIG. 2 depicts a method 200 for distributing power between components of a power distribution system, consistent with disclosed embodiments. Method 200 can be performed by a smart interface controller (e.g., smart interface controller 121). Though described with reference to a single power transfer value for simplicity, a similar approach can be used to determine one or more power transfer patterns.

The smart interface controller can use method 200 to determine a power transfer value between two nodes, consistent with disclosed embodiments. The power transfer value can depend on requested power transfer values indicated in power transfer requests received from each of the nodes. The requested power transfer value for a node can change as the power generation or consumption changes for that node. Method 200 can therefore enable the transfer of power between nodes to adjust based on changes in power generation or consumption for the nodes. However, in some embodiments, the smart interface controller may not receive information regarding the status of a node beyond the requested power transfer value. Information about, for example, the internal operations or status of the node, need not be transmitted by the node, improving the security of the system. In this manner, the disclosed embodiments can enable a power distribution system to adjust to changes in power generation or consumption, while improving the security of the power distribution system.

After starting in step 201, method 200 can proceed to step 210. In step 210, a smart interface controller can receive a power transfer request from a node (e.g., community node 110 or local node 123) connected to the smart interface controller. In some embodiments, the power transfer request can be received using a communication network connection between the node and the smart interface controller. For example, the node can be communicatively connected the smart interface controller by a wired or wireless communication network. In various embodiments, the power transfer request can be provided over a power connection (e.g., external power bus 130, internal power bus 140, or another suitable power connection) between the node and the smart interface controller. For example, the power transfer request can be encoded into changes in at least one of the voltage or current provided through the power connection. The changes in the at least one of the voltage or current can be decoded by the smart interface controller to obtain the power transfer request. The power transfer request can indicate a requested power transfer value. As described herein, the requested power transfer value can depend on management information of the node (e.g., a status of a storage component of the node). In some embodiments, the requested power transfer value can be provided as a plaintext value. As and additional example, the requested power transfer value can be provided as an obfuscated value or an encrypted value (e.g., using a symmetric or public key of the smart interface controller).

After starting in step 201, method 200 can proceed to step 220. In step 220, the smart interface controller can receive a power transfer request from another node connected to the smart interface controller. Similar to the power transfer request received in step 210, this second power transfer request can be received using a communication network connection or over a power connection between the smart interface controller and the second controller. Similar to the power transfer request received in step 210, this power transfer request can indicate a requested power transfer value, which can be in plaintext; obfuscated; or encrypted.

The smart interface controller can receive the power transfer requests in steps 210 and 220 according to a schedule, according to disclosed embodiments. For example, the smart interface controller can be configured to receive the power transfer requests at certain scheduled times of day (e.g., every fifteen minutes, hourly, or the like). In some embodiments, each of the nodes can be configured to provide power transfer requests according to the same schedule. In various embodiments, the nodes may provide power transfer requests according to different schedules (e.g., a different number of requests, or the same number of requests but differing times). For example, the nodes may provide power transfer requests at different frequencies, or the same frequency but offset or staggered. In some embodiments, as a security measure, the smart interface controller can be configured to block, discard, or ignore unscheduled power transfer requests.

The smart interface controller can receive the power transfer requests in steps 210 and 220 at times indicated by the nodes, according to disclosed embodiments. For example, a power transfer request received from a node can indicate a time the next power transfer request will be provided by that node. The indication can be the next absolute time, an offset from the current time, or some other suitable indication of the next time. In some embodiments, as a security measure, the smart interface controller can be configured to block, discard, or ignore power transfer requests received from a node when the time of that power transfer request was not indicated in a request previously received from that node.

The disclosed embodiments are not limited to embodiments in which power transfer requests are received at scheduled or indicated request times. For example, nodes can provide power transfer requests to the smart interface controller asynchronously (e.g., at varying times and with varying intervals between requests). As an additional example, a node can provide a power transfer request to the smart interface controller in response to a changed status of the node (e.g. changes in power generation or consumption, changes in the state of charge of a power storage component, or the like). In such embodiments, the smart interface controller may not be able to anticipate a request time. The smart interface controller can be configured to accept power transfer requests without reference to a scheduled or indicated request time.

After receiving power transfer requests in steps 210 and 220, method 200 can proceed to step 230. In step 230, the smart interface controller can determine a power transfer value using the received power transfer requests. The determined power transfer value can include a magnitude and direction of power transfer between the nodes. In some embodiments, the smart interface controller can be configured to use weights or priorities associated with the nodes to determine the power transfer value. In various embodiments, the smart interface controller can be configured to use safety criterions, such as maximum power criterions, to determine the power transfer value. FIG. 3 provides a non-limiting approach to determining the power transfer value based on the requested power transfer values included in the requests.

As can be appreciated from the foregoing discussion, the smart interface controller can be configured to determine the power transfer value without reference to management information associated with either of the nodes. In some embodiments, the smart interface controller can be configured to use the most-recently received power transfer request from each node when determining the power transfer value. In various embodiments, the smart interface controller can be configured to re-determine the power transfer value in response to receiving a new power transfer request from both smart interface controllers. In such embodiments, when one node provides power transfer requests more frequently than the other node, only the most recently received power transfer requests may be used. In some embodiments, the smart interface controller can be configured to re-determine the power transfer value in response to receiving a new power transfer request from at least one of the smart interface controllers. Such a determination may re-use a previously used power transfer request.

After determining a power transfer value in step 230, method 200 can proceed to step 240. In step 240, the smart interface controller can provide instructions to transfer power between the nodes based on the determined power transfer value. For example, the smart interface controller can configure a power converter to transfer the determined magnitude of power between the nodes in the determined direction. In some embodiments, when the power convertor is implemented separately from the smart interface controller, the smart interface controller can be communicatively connected to the power converter over a network and can provide the instructions over the network to configure the power converter.

After providing instructions in step 240, method 200 can proceed to step 250. In step 250, method 200 can finish. In various embodiments, the smart interface controller can be configured to restart method 200 in response to receiving one or more additional power transfer requests. In some embodiments, the smart interface controller can be configured to restart method 200 in accordance with a schedule, at a time indicated by a power transfer request, or after a predetermined amount of time.

FIG. 3 depicts a method 300 for determining a power transfer between components of a power distribution system, consistent with disclosed embodiments. Method 300 can be performed by a smart interface controller (e.g., smart interface controller 121). Method 300 can determine a power transfer value, where the power transfer value can indicate a magnitude and direction of power transfer between two nodes (e.g., community node 110 and local node 123). Method 300 can determine the power transfer value based on, at least in part, one or more power transfer requests received from the nodes, as described herein. In some embodiments, method 300 can further determine the power transfer value based on parameters (e.g., node priority, weights, safety criteria, or the like) of the smart interface controller. Though described herein with regards to a single power transfer value for simplicity of explanation, method 300 can be performed using the power transfer values comprising one or more power transfer patterns.

After starting in step 301, method 300 can proceed to step 303. In step 303, the smart interface controller can determine, based on the power transfer requests received from the nodes, whether the nodes have requested consistent power transfer directions. For example, when a node requests power and the other node requests to provide power, the nodes have requested consistent power transfer directions. As an additional example, when both nodes request power or request to provide power, the nodes have not requested consistent power transfer directions. Depending on whether the nodes request consistent power transfer directions, method 300 can proceed to either step 305 or step 307.

After determining that the nodes request consistent power transfer directions in step 303, method 300 can proceed to step 305. In step 305, the smart interface controller can determine a power transfer value. This power transfer value can be based on the requested power transfer values provided by the nodes. The determined power transfer direction can be the direction of the requested power transfer values (as these requested power transfer values have a consistent direction). The determined magnitude of power transfer can be a function of the magnitudes of the requested power transfers (e.g., a minimum of the requested power transfer magnitudes, a maximum of the requested power transfer magnitudes, a weighted or unweighted average of the requested power transfer magnitudes, or the like). After determining the magnitude and direction of power transfer, method 300 can proceed to step 315.

After determining that the nodes request inconsistent power transfer directions in step 303, method 300 can proceed to step 307. In step 307, the smart interface controller can determine a power transfer value. This power transfer value can be based on the requested power transfer values provided by the nodes. The power transfer value can further be determined by any weights associated with the nodes. In some embodiments, the greater the difference between the weights associated with the nodes, the more similar the determined power transfer value can be to the requested power transfer value of the node with the greatest weight. For example, when a community node (e.g., community node 110) and a local node (e.g., local node 123) both request 1 kW in power transfer, and both have equal weights, the determined power transfer may be 0 W. When the weight of the local node is greater than the weight of the community node, the direction of the determined power transfer value may be towards the local node. The difference between the weight of the community node and the weight of the local node can determine the magnitude of the determined power transfer value. In some embodiments, the determined power transfer can be the average of the requested power transfer values (with some sign convention indicating the direction of power transfer), weighted by the weights associated with the nodes. The disclosed embodiments are not limited to any particular formula for determining the power transfer value. After determining the magnitude and direction of power transfer, method 300 can proceed to step 309.

In step 309, the smart interface controller can determine whether the determined power transfer is consistent with the power transfer request from the higher priority node. As described herein, a priority of a node can reflect assumptions about the generation and power storage capacity of a node, the sensitivity of a node to power loss, or similar concerns. Thus, in some embodiments, the smart interface controller can be configured to apply additional conditions to power transfers in directions contrary to the request of a higher priority node. When the determined power transfer value is in the direction requested by the higher priority node, method 300 can proceed to step 315. Otherwise, method 300 can proceed to step 311.

In step 311, the smart interface controller can be configured to determine whether the power transfer request satisfies conditions imposed on the transfer of power, when that transfer is contrary to the request of the higher priority node. For example, the smart interface controller can impose conditions on the maximum power transfer magnitude contrary to the request of the higher priority node. In some embodiments, power transfer magnitudes exceeding this maximum can indicate a fault in the lower priority node. When the power transfer request satisfies the conditions imposed on transfers of power contrary to the request of the higher priority node, method 300 can proceed to step 315. Otherwise method 300 can proceed to step 313.

Similarly, in some embodiments, the smart interface controller can be configured to determine whether a power transfer in a direction contrary to the requested direction of a lower priority node satisfies any conditions on such transfer. Failure to satisfy such conditions can result in the smart interface controller modifying the determined power transfer magnitude, as described with regards to step 313.

In step 313, the smart interface controller can respond to the failure to satisfy a condition on power transfers contrary to the high-priority request. In some embodiments, the smart interface controller can be configured to modify the determined power transfer magnitude. For example, the smart interface controller can be configured to set the magnitude of the power transfer to a predetermined value (e.g., to zero, or to some non-zero default level, or a similar predetermined value). In various embodiments, the response of the smart interface controller can depend on the condition violated. For example, when the condition is a maximum power transmission condition, such that violation of the condition indicates a potential fault in the low-priority node, the smart interface controller can be configured to set the power transfer magnitude to zero. Method 300 can then proceed to step 315.

In step 315, the smart interface controller can be configured to implement the determined power transfer value. In some embodiments, the smart interface controller can include, or be configured to communicate with, a power converter connecting the nodes. The smart interface controller can configure the power converter to transfer power according to the determined power transfer value.

After step 315, method 300 can proceed to step 320. In step 320, method 300 can stop. In some embodiments, method 300 can restart when additional power transfer requests are received from one or more of the nodes, according to a schedule, at an indicated time, or upon satisfaction of another suitable criterion. In some embodiments, method 300 can be repeatedly restarted, as conditions in the nodes are adjusted and additional power transfer requests received.

Exemplary Power Distribution Topologies

The disclosed embodiments include DC power distribution system topologies configured to provide redundant and scalable distribution of power to users. These DC power distribution system topologies can be combined with fault detection, isolation, and remediation methodologies that provide improved protection of people and infrastructure during fault events. Such methodologies may support fault detection (or fault detection and remediation, such as depowering a power line) within microseconds to milliseconds (e.g., 10 to 1000 microseconds, or preferably less than 500 microseconds), in contrast to conventional systems, which may require milliseconds to seconds (e.g., hundreds of milliseconds) to detect (or detect and remediate) a fault.

Power distribution lines, consistent with disclosed embodiments, can be connected to a community node and can deliver power from the community node to one or more local nodes. Such power distribution lines can be in series with switches. To remediate fault events, such switches can transition between open and closed states to isolate power distribution lines from other portions of a power distribution system. In some embodiments, remediation of fault events can include isolating portions of a power distribution line. Disclosed systems can enable or interrupt power supply to all or a portion of a power distribution line. The disclosed embodiments can be configured to enable rapid discharging of power distribution lines and protection of people, animals, and equipment in the event of a fault by limiting capacitive energy storage in power distribution lines. In some embodiments, characteristics of the power distribution lines (e.g. capacitance, voltage difference between the power distribution lines or between each power distribution line and ground, or the like) can be selected such that the capacitive energy stored by the power distribution lines during typical operation is unlike to harm a human or animal electrically contacting the power distribution lines (e.g., the capacitive energy stored by the power distribution lines during typical operation may be 10 Joules or less). The capacitance of the power distribution lines can be adjusted through selection of the cable type (e,g., parallel conductor with controlled spacing, coaxial cable, twisted pair or the like) used to implement the power distribution lines, the installation method of the power distribution lines (e.g., direct burial, conduit, overhead, or the like), or the dimensions of the power distribution lines (e.g., length of a power distribution lines). Further, disclosed embodiments can enable rapid detection of fault events and permit distinguishing of different types of fault events by including grounding resistances that are comparable to the range of resistances of dry intact human skin (e.g., 1 kOhm to 100 kOhm, more preferable 2 kOhm and 50 kOhm, or more preferably 4 kOhm and 20 kOhm). Further, disclosed DC Power distribution topologies facilitate decentralized power distribution supply, as described herein.

The disclosed embodiments may further support convenient scalability and resilience. A new development or subdivision can be supported by adding a new community node, with the residences or commercial establishments connected as local nodes. The new community node may, in turn, serve as a local node for another node with greater energy provision or storage capabilities (e.g., in a hierarchical power distribution system), or may be connected to a conventional power distribution network. Community nodes may be connected into a resilient network or mesh, with community nodes sharing power as needed. In this manner, the disclosed topologies can improve upon conventional power distribution topologies.

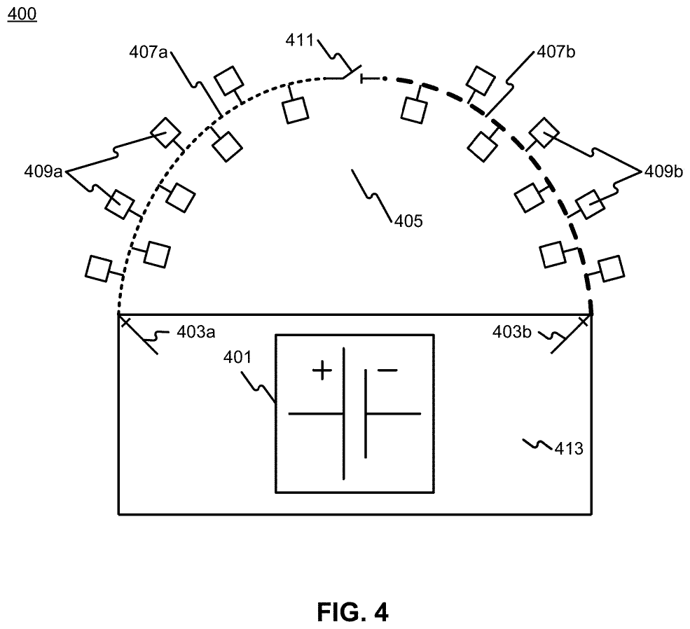

Disclosed embodiments include a community DC power distribution system. FIG. 4 depicts exemplary DC power distribution system 400, consistent with disclosed embodiments. A community DC power distribution system can be configured to provide DC power to local nodes (e.g., local nodes 409a, 409b as shown in FIG. 4) associated with residential facilities, business facilities, government facilities, and/or other facilities. A DC power distribution system can include or be a component of a decentralized power distribution system, consistent with disclosed embodiments.

A DC power distribution system of the embodiments can include a community node. FIG. 4 depicts exemplary community node 413 having at least two power distribution points associated with respective switches 403a and 403b and at least one voltage source 401. A community node can include any community node as previously described and/or any other node configured to transfer power to and from itself to other nodes. For example, a community node can be connected to multiple local nodes (e.g., local nodes 409a, 409b) through multiple smart interface controllers. A DC power distribution system can include a network of one or more community nodes and one or more local nodes. Community nodes and local nodes can be configured to configured to transfer power through a network of nodes. For example, local nodes may comprise respective local energy storage components, and a community node can be configured to charge the respective local energy storage components through power distribution lines

In some embodiments, a community node can include one or more communication devices, such as a transceiver capable of connecting to a cellular network (e.g., a 5G antenna), a Wi-Fi network, a Li-Fi network, a local area network, a wired internet connection, and/or any other wired or wireless network. A community node can be configured for communication with components at a local node computing system, a server, a cloud-based system, a user device, and/or any other computing system. in some embodiments, a community node may communicate with other system components or external system components using signals passed through lines configured to provide power (e.g., power distribution lines or the like).

In some embodiments, a community node can include one or more voltage sources such as, for example, one or more energy storage components as disclosed herein. FIG. 4 depicts exemplary voltage source 401. Alternatively or additionally, a voltage source of a community node can include an AC voltage input and a converter that accepts AC power and provides DC power output. A voltage source can be configured for high voltage DC power transmission. As non-limiting examples, a voltage source can be configured to apply at least 380V or at least 15,000V. In some embodiments, a community node can be floating with respect to ground.

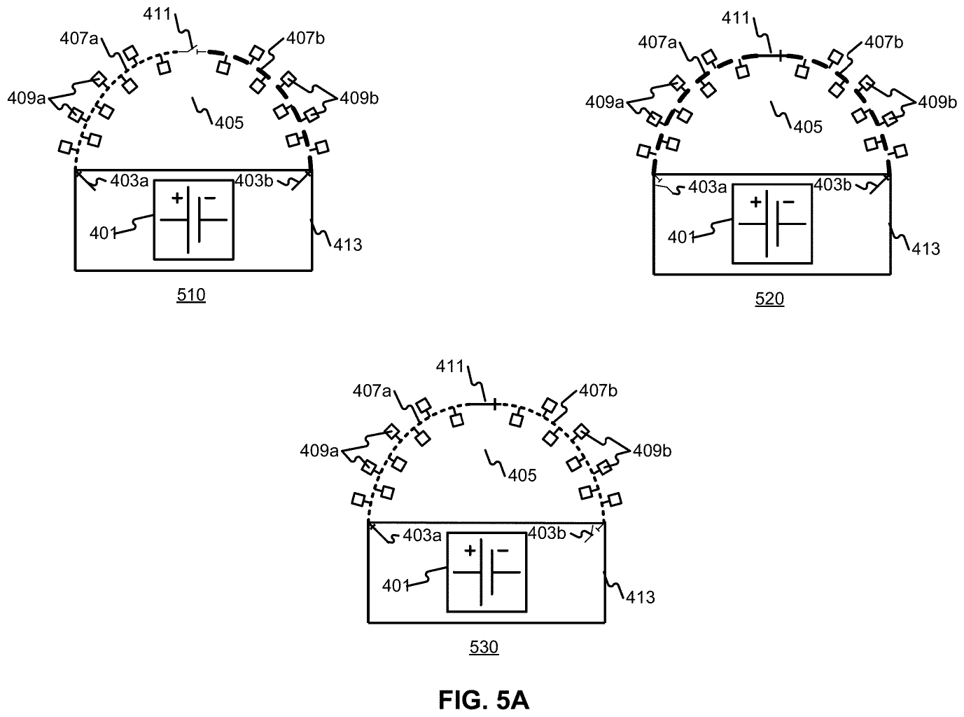

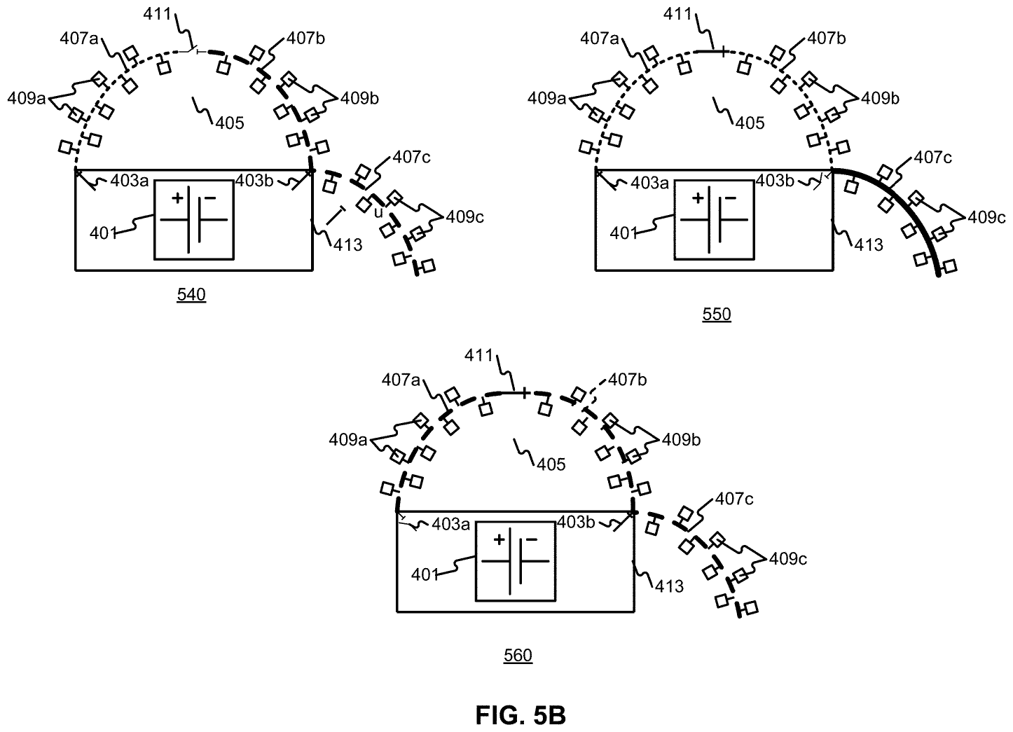

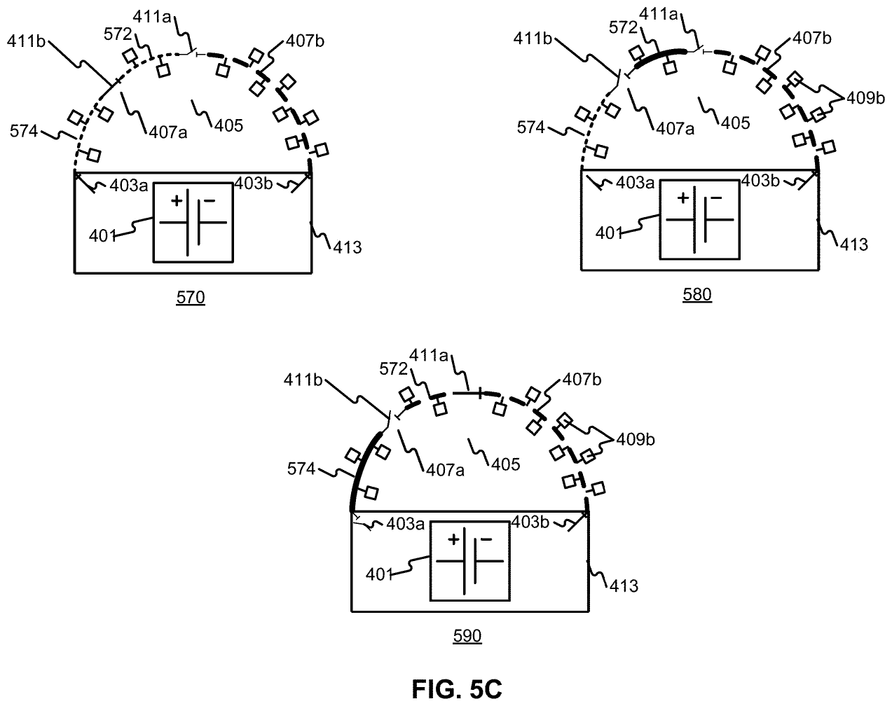

In some embodiments, a community node can include one or more switches configured to transition between open and closed states (e.g., a first switch 403a and a second switch 403b, as shown in FIGS. 4-5C). A switch can be configured to permit the flow of electrical current between one or more components of a DC power distribution when the switch is in a closed state. A switch in an open state can prevent the flow of electrical current between one or more components of a DC power distribution system. A switch may be in an open state with respect to one component and in a closed state with respect to another component. For example, a switch may toggle between first and second power distribution lines to permit current to flow through the first lines but not the second lines.

FIGS. 4 and 5A to 5C each depict one or more of exemplary switches 403a, 403b, 411, 411a, and 411b. Switches of the present embodiments can include single pole single throw, double pole double throw, and/or any number of poles or throws. Each of the switches can be or include mechanical switches, solid-state switches, or a combination of mechanical and solid-state switches. A switch can be or include a semiconductor switch, an isolator switch, a circuit breaker switch, an air break switch, a relay, a fuse, a limit switch, a selector switch, a temperature actuated switch, a manual switch, and/or other types of switch for high voltage systems. Switches can include internal components, such as contacts, springs, and/or other equipment for creating or breaking electrical connections, for example. As used herein, the term switch can refer to one switch or a combination of switches configured to control electrical connectivity between multiple system components. A switch can be a component of a protective device for isolating or deenergizing power distribution lines. As one of skill in the art will appreciate, a DC power distribution system consistent with the present embodiments may still include other types of switches.

A switch can be configured to transition between an open and closed state in response to a received command, to a change in voltage, to a change in current, to a change in a rates of change of voltage, to a change in a rate of change of voltage, a detected fault condition, and/or other triggering events. For example, a switch may transition between states in response to detection of a voltage that falls within or outside a range, exceeds a threshold voltage, or fails to reach a threshold voltage (e.g., an over-voltage condition or under-voltage condition). A switch may transition in response to a ground fault event. A switch may transition between states based on a signal from a smart interface controller associated with the switch, consistent with disclosed embodiments.

Consistent with the present embodiments, a community DC power distribution system can include a power distribution loop, and a community node can transfer power to a portion of a power distribution loop and/or all of a power distribution loop. FIGS. 4-5C depict exemplary instances of power distribution loop 405. Such power distribution loops can permit transfer of energy from a community node via one or more power distribution lines and at least one switch to one or more local nodes. A power distribution loop can be electrically connected to a community node via switches at two ends of the loop.

A power distribution loop can include one or more power distribution lines electrically connected to two switches of the community node power distribution and one or more switches along the power distribution lines or at ends of the power distribution lines. For example, a power distribution loop can include power distribution lines in electrical contact with two switches of the community node at respective ends of the lines. As shown in FIGS. 4 by way of example, first power distribution lines 407a and second power distribution lines 407b are connected to switches 403a and 403b, respectively. In the illustrative configuration depicted in FIG. 4, switches 403a and 403b that are in closed states, allowing voltage source 401 to provide power to their respective power distribution lines as represented by the dotted lines (407a) and dashed lines (407b).

Current may flow between a community node and all or a portion of a power distribution loop via a switch of the community node in a closed state, and current may be interrupted at one or more switches in open states along a power distribution loop. For example, switch 411 is depicted along the power distribution loop 405 in an open state in FIG. 4, thereby preventing current from flowing between the first power distribution lines 407a and second power distribution lines 407b of power distribution loop 405.

Power distribution lines of the present embodiments can be in electrical contact with one or more local nodes (e.g., first local nodes 409a and second local nodes 409b). Local nodes can include any local node as disclosed herein. Local nodes can be associated with respective residences, businesses, health care facilities, refugee camp infrastructure, government infrastructure, construction site infrastructure, mining infrastructure, temporary infrastructure, and/or any other infrastructure. For example, first power distribution lines of a power distribution loop can be in electrical contact with between 5 and 100, or more local nodes associated with respective residences (e.g., at least 10 local nodes, 25 local nodes, 50 local nodes, or more). The number of local nodes can depend on the resistivity of the power distribution lines (e.g., the number may be selected to prevent excessive droop in the voltage at the distal end of the power distribution lines), the amount of energy capacitively stored in the power distribution lines (e.g., the power distribution lines may be limited to a length storing less than 10 joules, or less than 5 joules, when energized to, for example, between 380 to 15,000 volts), the relative separation of the local nodes, and similar factors.

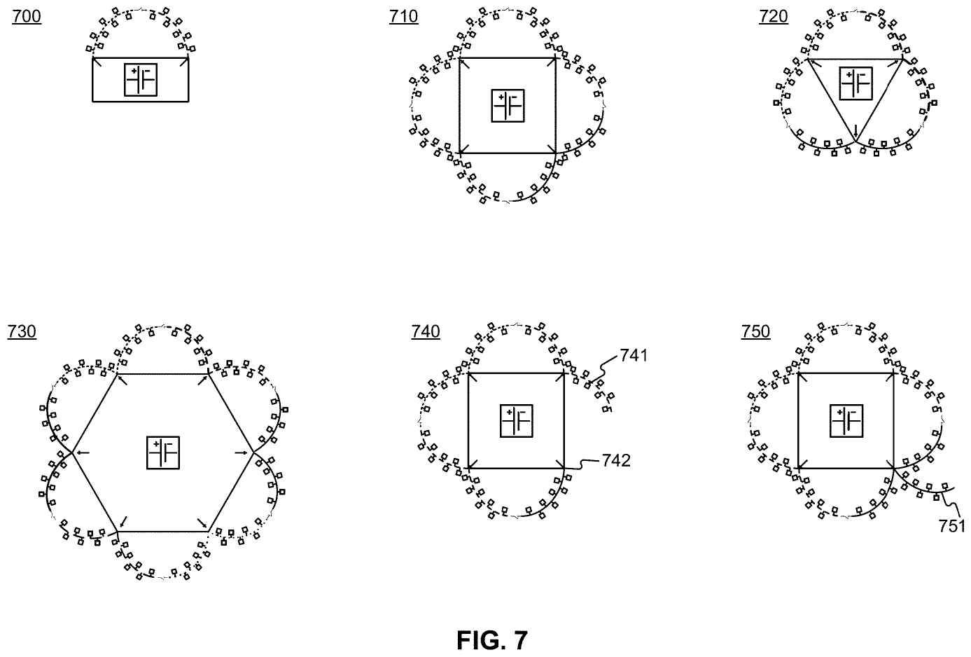

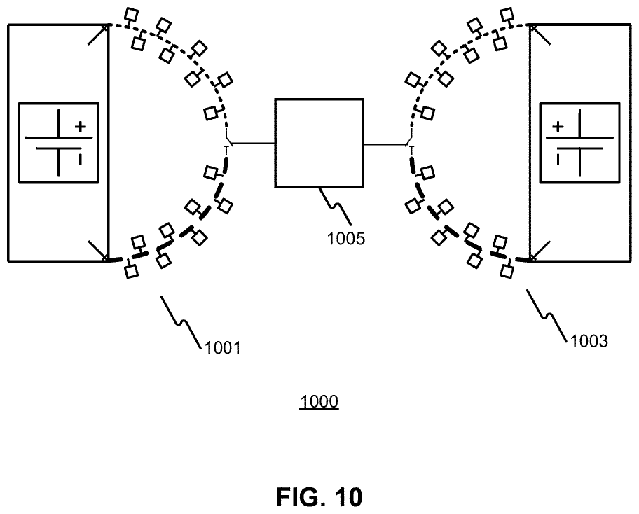

In some embodiments, a community DC power distribution system can include orphan power distribution lines that are not components of a power distribution loop (e.g., lines electrically connected to a community node at only one point such as power distribution lines 741 and 751 of FIG. 7). In some embodiments, power distribution loops can be connected to power distribution loops of other DC power distribution systems (see e.g, FIG. 10).

In some embodiments, power distribution lines of a power distribution loop can be configured to be grounded through respective resistances of between 1 kOhm and 100 kOhm, between 2 kOhm and 50 kOhm, or, more preferably, of between 4 kOhm and 20 kOhm. The ground resistor values can be selected to aid in identification of harmful faults. In some embodiments, the power distribution system can be configured to distinguish an electrical contact between a power distribution line and a person (or animal) from an electrical contact between a power distribution line and a tree, leaf, or other higher-resistance object. Resistances within these ranges may be similar to a resistance of a human body through skin. Thus, by using a ground resistor these resistance ranges, a person in contact with the line may provide a path to ground of similar magnitude to the ground resistor.

The additional, similarly conductive path to ground through the person can shift the voltage differences of the power distribution lines with respect to ground. The community node, or another computing device in the power distribution system, can detect this shift in voltage differences with respect to ground. In response, the community node or other computing device can take corrective action (e.g., depowering the power distribution lines, generating an alert or other indication of a potential fault, providing the alert of indication to one or more persons, monitoring systems, community nodes, local nodes, or other suitable corrective action). In some embodiments, the ground resistances can be selected so that voltage shifts resulting from contact with other, higher-resistance objects (e.g., a branch or a leaf) can be better distinguished from voltage shifts resulting from contact with a person or animal. The system therefore reduces false positive detections of harmful contact. The disclosed embodiments can therefore reduce potential service disruptions and expenses associated with such false positives. In some embodiments, as false positives are less likely, the power distribution system can support more sensitive criteria for taking corrective actions (e.g., taking corrective actions faster in response to detected voltage shifts, or in response to smaller or more-transient voltage shifts, or the like) or more aggressive corrective actions (e.g., depowering a power distribution line as opposed to only providing an alert, or the like). In this manner, the choice of resistances can improve the stability and safety of the power distribution system.

In various embodiments, the ground resistances can further be selected to reduce power loss through the grounding resistors and limit current flow through a fault electrically connecting one power line to ground. In some instances, current flow through the grounding resistors can represent an inefficiency in the system. By selecting the grounding resistors in the specified range, this inefficiency can be reduced. Furthermore, the ground resistors can be selected to reduce current through a ground fault to levels less likely to cause death or injury (e.g., less than 10 to 100 mA).

In some embodiments, the power distribution lines can be configured to have a voltage difference between 300 and 15,000 V, or more. In some embodiments, the power distribution lines can be configured to have a voltage difference of at least 380V, at least 760V, or at least 1520V. In various embodiments, power distribution lines can be configured to have a voltage difference of at least 15,000V. A community node may apply a voltage from the voltage source to the power distribution lines of, for example, between 300 and 15,000 V, or more. A community node can include a distributor comprising a switch and/or an interface controller for applying voltage to power distribution lines. A distributor can include a shunt and/or an inductor electrically connected to power distribution lines.

Power distribution lines may have various properties and configurations. For example, power distribution lines can include a positive line and negative line jointly installed in a single conduit. The power distribution lines can be configured for direct-burial installation (e.g., designed for emplacement in a trench without requiring installation in a conduit) up to a voltage difference of at least 380V (or in some embodiments at least 760V, at least 1520V, or more). Further, power distribution lines consistent with disclosed embodiments can be configured for a capacity of at least 400 amperes current (e.g., such power distribution lines can be configured to provide 400 amperes, 600 amperes, 1200 amperes, or more during normal operation). In some embodiments, a length of power distribution lines can be configured to limit capacitive energy storage to less than 10 Joules or less than 5 Joules when the first power distribution lines have a voltage difference of at least 380V, at least 760V, at least 1520V, or at least 15,000V. By limiting capacitance to less than 10 Joules or less than 5 Joules, serious injury and/or death may be prevented when a person comes in contact with power distribution lines (e.g., as the result of a fault, or as the cause of a fault).

In some embodiments, a switch of a community DC power distribution system can be electrically connected to a switch of another community DC power distribution system to enable power exchange (e.g., as shown in FIG. 10). A community DC power distribution system can include a smart interface controller for managing power transfer, the smart interface controller including at least one processor and at least one memory storing instructions that, when executed by the at least one processor, cause the smart interface controller to perform operations. Operations can include receiving, from the community node, a first power transfer request for the community node. The first power transfer request indicating a requested power transfer value based at least in part on a status of an energy storage component of the community DC power distribution system. The operations can include receiving, from a second community DC power distribution system electrically connected to the first switch to enable power exchange between the community DC power distribution system and the second community distribution DC power distribution system, a second power transfer request for the second community DC power distribution system. Operations can include determining a power transfer value between the community node and the second community DC power distribution system based at least in part on the first power transfer request and the second power transfer request. The operations can include providing, to a power converter, instructions to transfer power between the first node and the second node according to the determined power transfer value via the third switch.

In some embodiments, a community node can be configured to repeatedly determine first power transfer requests based at least in part on a status of an energy storage component of the community node. In some embodiments, local nodes can include respective energy storage components and can be configured to repeatedly determine second power transfer requests based at least in part on statuses of the respective energy storage components. A community DC power distribution system can further include a smart interface controller configured to transfer power between the community node and the first nodes. The smart interface controller can be configured to repeatedly update values of the power transfer based on a present first power transfer request and a present second power transfer request.

FIGS. 5A to 5C depict exemplary DC power distribution systems in various configurations 510, 520, 530, 540, 550, 560, 570, 580, and 590. As a non-limiting example, in some embodiments, a power distribution loop can include first power distribution lines electrically connected to a first switch of the community node (e.g., connected to switch 403a at one end of first power distribution lines 407a), second power distribution lines electrically connected to a second switch of the community node (e.g., connected to switch 403b at one end of second power distribution lines 407b), and a third switch electrically connected to the first and second power distribution lines (e.g., switch 411 connected to ends first and second power distribution lines 407a, 407b). In some embodiments, the power distribution lines can be high-voltage power distribution lines, having a voltage between them greater than or equal to 380V (e.g. at least 380V, at least 760V, at least 1520V, or at least 15,000V).

A community node can be configured to provide power to the first local nodes via the first power distribution lines and the second local nodes via the second power distribution line when the first and second switches are in closed states and the third switch is in an open state. As shown in exemplary configuration 510, dotted lines illustrate that first power distribution lines 407a are energized to provide power to first local nodes 409a via switch 403a in a closed state. Dashed lines illustrate that second power distribution lines 407b are energized to provide power to second local nodes 409b via switch 403b in a closed state. Third switch 411 is in an open state, preventing current from flowing between first and second power distribution lines 407a, 407b.

A community node can be configured to provide power to first local nodes via first distribution lines and second local nodes via second distribution lines when a first switch is in an open state, a second switch is in a closed state, and a third switch is in a closed state. For example, as illustrated by dashed lines in configuration 520, first power distribution lines 407a and second power distribution lines 407b are energized to provide power to first local nodes 409a and second local nodes 409b, respectively. In configuration 520, first switch 403a is in a closed state, second switch 403b is in a closed state, and third switch 411 is in a closed state.

As another example, a community node can be configured to provide power to first local nodes via first distribution lines and second local nodes via second distribution lines when a first switch is in a closed state, a second switch is in an open state, and a third switch is in a closed state. For example, as illustrated by dashed lines in configuration 530, first power distribution lines 407a and second power distribution lines 407b are energized via switch 403a to provide power to first local nodes 409a and second local nodes 409b.

In some embodiments, the community DC power distribution system can include third power distribution lines and the community node can be configured to provide power to the third local nodes via the third power distribution lines when the second switch is in a closed state. For example, exemplary configuration 540 depicts dashed lines representing third power distribution lines 407c energized to provide power to third local nodes 409c via second switch 403b in a closed state. Third power distribution lines 407c can be a component of a power distribution loop other than loop 405 (not shown in FIG. 5B). In some embodiments, third power distribution lines can be orphan power distributions lines that do not belong to a power distribution loop and are configured to receive power from community node 413 only via switch 403b (i.e., the third distribution lines may not be components of a power distribution loop). Third power distribution lines 407c can be electrically connected to any number of switches along or at the end of its lines (not shown in FIG. 5B).

A switch can be configured to transition from a closed state to an open state to isolate third local nodes based on a fault in the third power distribution lines. As shown in configuration 550, a solid line represents that third power distribution lines 407c are deenergized to isolate third local nodes 407c when second switch 403b transitions from a closed state (configuration 540) to an open state (configuration 550). Third local nodes 409c can include all nodes associated with third power distribution lines 407c or a portion of the nodes. For example, all or a portion of third power distribution lines may be deenergized and isolated for community node 413 when second switch 403b is in an open state.

In some embodiments, a switch can be configured to transition from a closed state to an open state based on a fault. In configuration 550, a third switch 411 is depicted as having transitioned from an open state (configuration 540) to a closed state (configuration 550) based on a fault in third power distribution lines 407c, a fault associated with second switch 403b, or a fault in a system component connected to third power distribution lines 407c (e.g., a remote switch or another power distribution line). A community node can be configured to provide power to first local nodes via first power distribution lines and to provide power to second local nodes via second power distribution lines (dotted lines of configuration 550).

As another example configuration, switch 403a may transition from a closed state (configuration 540) to an open state (configuration 560) and switch 411 may transition to a closed state to permit power transfer between community node 413 and first, second, and third power distribution lines 407a, 407b, and 407c via switch 403b. The example of configuration 560 illustrates that components to a DC power distribution system consistent with the present embodiments can be configured to provide power from a single switch of a community node to at least three power distribution lines.

In some embodiments, first power distribution lines and second power distribution lines of a power distribution loop can be electrically connected to a fourth switch. For example, configuration 570 depicts fourth switch 411b in a closed state. Switch 411b separates portions 572 and 574 of first power distribution lines 407a. More generally, power distribution lines can be electrically connected to any number of switches along the lines and/or at the ends of lines to separate any number of portions of power distribution lines from community nodes and/or each other. When isolating portions of power distribution lines local nodes associated with the isolated portions are also isolated.

Switches of a power distribution loop can be configured to isolate at least a portion of power distribution lines from a community node and/or from other portions of power distribution lines when two switches are in open states and at least one other switch is in a closed state. For example, configuration 580 demonstrates that fourth switch 411b can be configured to isolate at least portion 572 of first power distribution lines 407a from community node 413 when fourth switch 411b is in an open state, first switch 403a is in a closed state, and third switch 411a is in an open state. Portion 574 is connected to community node 413 via closed switch 403a to enable transfer of power between local nodes associated with portion 574 and community node 413. Alternatively, configuration 590 illustrates that fourth switch 411b can be configured to isolate at least portion 572 of first power distribution lines 407a from the community node when first switch 403a is in an open state, third switch 411a is in a closed state, and the second switch 403b is in a closed state.

As one of skill in the art will appreciate, transitions of switches as depicted in FIG. 5A-5C can be based on conditions in addition to a fault or instead of a fault (e.g., for scheduled maintenance, to enable construction, for inspections, to isolate community DC power distribution system from another distribution system, and/or for any other activity).

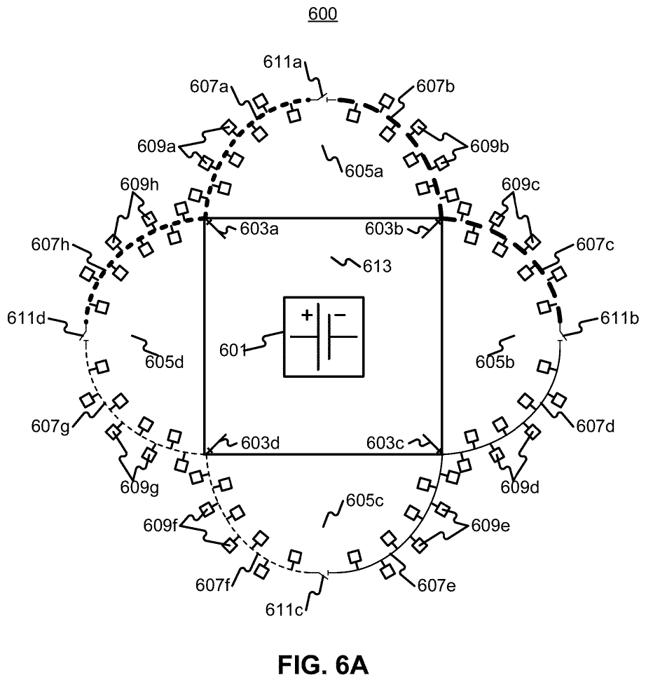

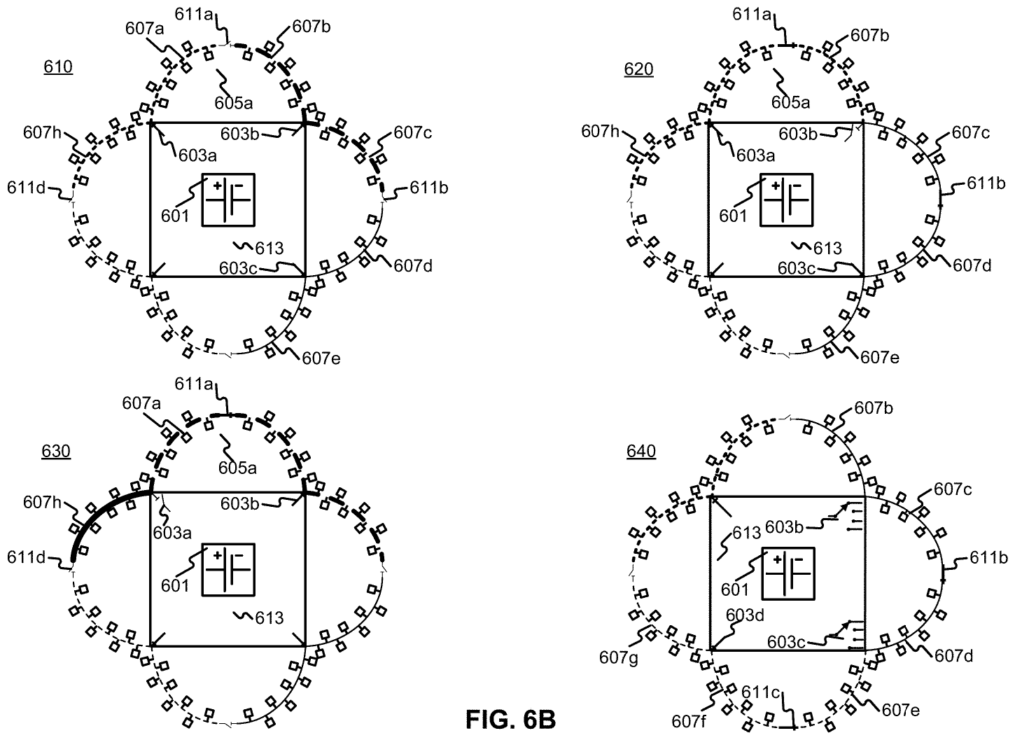

FIG. 6A illustrates exemplary community DC power distribution system 600 having a clover leaf topology, consistent with disclosed embodiments. System 600 can include community node 613. Community node 613 can include voltage source 601, switches 603a, 603b, 603c, and 603d. System 600 can include power distribution loops 605a, 605b, 605c, and 605d. As illustrated, power distribution loops of system 600 can include power distribution lines 607a, 607b, 607c, 607d, 607e, 607f, 607g, and 607h electrically connected to respective local nodes 609a, 609b, 609c, 609d, 609e, 609f, 609g, and 609h. Further, power distribution loops 605a, 605b, 605c, and 605d can include switches 611a, 611b, 611c, and 611d.

Community node 613 can be configured to apply voltage source 601 to power distribution lines via switches 603a, 603b, 603c, and 603d. Switches 603a, 603b, 603c, and 603d can be configured to permit power transfers to one or more power distribution lines. Thus, system 600 is configured to enable power transfer between local nodes and community node 613. As shown, for example, switch 603a is in a closed state to permit community node to transfer power to local nodes 609a and 609h via respective power distribution lines 607a and 607h.

Community DC power distribution system 600 can include be or include any community DC power distribution system consistent with the present disclosure. For example, power distribution loops 605a, 605b, 605c, and/or 605d can include features and components of power distribution loop 405a. Further, one of skill in the art will appreciate that individual ones of power distribution loops, switches, power distribution lines, local nodes, and community nodes of system 600 can adopt any of the configurations depicted in FIGS. 5A-5C.

FIG. 6B illustrates exemplary configurations 610, 620, and 630 of community DC power distribution system 600. As illustrated in the configurations of FIG. 6B, the present embodiments can provide advantages for dealing with faults and/or other power distribution interruptions. These examples illustrate that DC power distribution systems of the present embodiments can be flexibly configured to isolate, interrupt, enable power transmission to local nodes in a variety of ways, with built-in redundancies and alternative configuration states to ensure continued power provision despite interruptions. For example, power distribution lines 607b can receive power from community node 601 in along at least three different pathways to handle different fault configurations: via switch 603b (e.g., configurations 610, 630), via switch 603a (e.g., configuration 620), and via switch 603c (e.g., configuration 640). As one of skill in the art will appreciate, the exemplary configurations presented in FIG. 6B are not limiting on the embodiments and still other configurations, not depicted, are consistent with disclosed embodiments.

In configuration 610, community node switches 603a, 603b, and 603c are in closed states to provide power to power distribution lines. For example, community node 613 applies voltage source 601 to power distribution lines 607a and 607h via switch 603a; to power distribution lines 607b and 607c via switch 603b; and to power distribution lines 607d and 609e via switch 603e.

In configuration 620, switch 603b may have transitioned from a closed state (e.g., as in configuration 610) to an open state. The transition can be based on and/or triggered by a detected fault and/or other conditions. For example, switch 603b or other components of community node 613 associated with switch 603b may experience a failure or fault. By transitioning switch 603b to an open state, power distribution lines 607b and 607c (or equipment connected to these power distribution lines) may be protected from harm due to the fault. As also shown in configuration 620, switches 611a and 611b may have transitioned from an open state (e.g., as in configuration 610) to closed state to enable power transfer between community node 613 and distribution lines 607b and 607c, respectively. In this way, via switch 603a, community node 613 can apply voltage source 601 to power distribution lines 607h and power distribution loop 605a, including power distribution lines 607a and 607b (thick dashed lines). Likewise, via switch 603c, community node 613 can apply voltage source 601 to power distribution lines 607c and power distribution loop 605b, including power distribution lines 607c and 607d (solid lines). As the example illustrates, the community nodes can at least be configured to power two and three power distribution lines via one point of distribution associated with a switch of the community node.

As another example, configuration 630 switch 603a may have transitioned from a closed state (e.g., as in configuration 610) to an open state while switch 611d is in an open state to isolate power lines 607h from community node 613. The transition can be based on a detected fault or other condition, as disclosed herein. For example, a fault in power distribution lines 607h and/or associated local nodes may trigger a transition of switch 603a. In some embodiments, a portion of power distribution lines 607h can be isolated between switch 603a and another switch located along power distribution lines 607h (e.g., as described in reference to configuration 590). In configuration 630, switch 611a may have a transitioned from an open state to a closed state to enable community nodes 613 to apply voltage source 601 to power distribution lines 607a via switch 603b.

In some embodiments, a switch connecting two power distribution lines to the community node may be in an open state with respect to one of the power distribution lines and in a closed state with respect to the other power distribution line. For example, in configuration 640 switch 603c is in a closed state with respect to power distribution lines 607d and in an open state with respect to power lines 607e; switch 611b is in a closed state; and switch 603b can be closed with respect to community node 613d but open with respect to power distribution lines 607c and 607b. In this configuration, community node 613 can apply voltage source 601 to power distribution lines 607d, 607c, and 607b via switch 603c. Also as shown, switch 611c can be in a closed state, and community node 613 can apply voltage source 601 to power distribution lines 607e, 607f, and 607g via switch 603d.

Clover leaf topologies can include systems such as those illustrated in FIGS. 6A and 6B, which are presented for purposes of illustration only and are not limiting on the disclosed embodiments. Although FIGS. 6A and 6B illustrates symmetrically shaped DC power distribution systems having approximately equally sized power distribution loops and power distribution lines, these exemplary depictions are not intended to be limiting. As described below with regards to FIG. 7, envisioned embodiments encompass DC power distribution systems with asymmetric power distribution loops that differ in length, number or arrangement of switches, node of local nodes serviced. Likewise, the term “clover leaf topology” is not limited to power distribution systems having four symmetric distribution loops, but encompasses power distribution systems having asymmetric power distribution loops; or power distribution systems having greater or fewer than four distribution loops. Envisioned topologies can include additional components not depicted in FIGS. 6A and 6B, such as additional community nodes, power generation sources, power storage sources, or the like.

FIG. 7 depicts exemplary topologies 700, 710, 720, 730, 740, and 750 of DC power distribution systems, consistent with disclosed embodiments. Examples of FIG. 7 are presented using symbols consistent with FIGS. 4 through 6B, including representations of community nodes, voltage sources, local nodes, power distribution lines, switches, power distribution loops, and other components.

Topology 700 depicts a community DC power distribution system with at least two community node switches connected to a power distribution loop as previously described in reference to FIG. 4, for example. Topology 710 depicts a community DC power distribution system having a clover leaf topology with at least four community node switches as disclosed in reference to FIGS. 6A and 6B.

Generally, community DC power distribution system can comprise any number of community node switches and power distribution loops. For example, topology 720 depicts a system with at least three community node switches and three power distribution loops, while topology 730 depicts a system with at least six community node switches and six power distribution loops. One of skill in the art will understand that additional topologies are consistent with the present embodiments.

Further, as disclosed herein, community DC power distribution system can include orphan power distribution lines that do not belong to a power distribution loop and are configured to receive power from a community node via one community node switch. For example, topology 740 depicts an orphan power distribution line 741 and a community node switch 742 that is connected to just one power distribution loop. Topology 750 depicts an orphan power distribution line 751 that connects to a one community node switch which is also connected to two power distribution loops.

The example topologies of FIG. 7 are not limiting on the embodiments, and community DC power distribution systems consistent with the present embodiments can include any number of community node switches, power distribution loops, and/or orphan power distribution lines not depicted in FIG. 7.

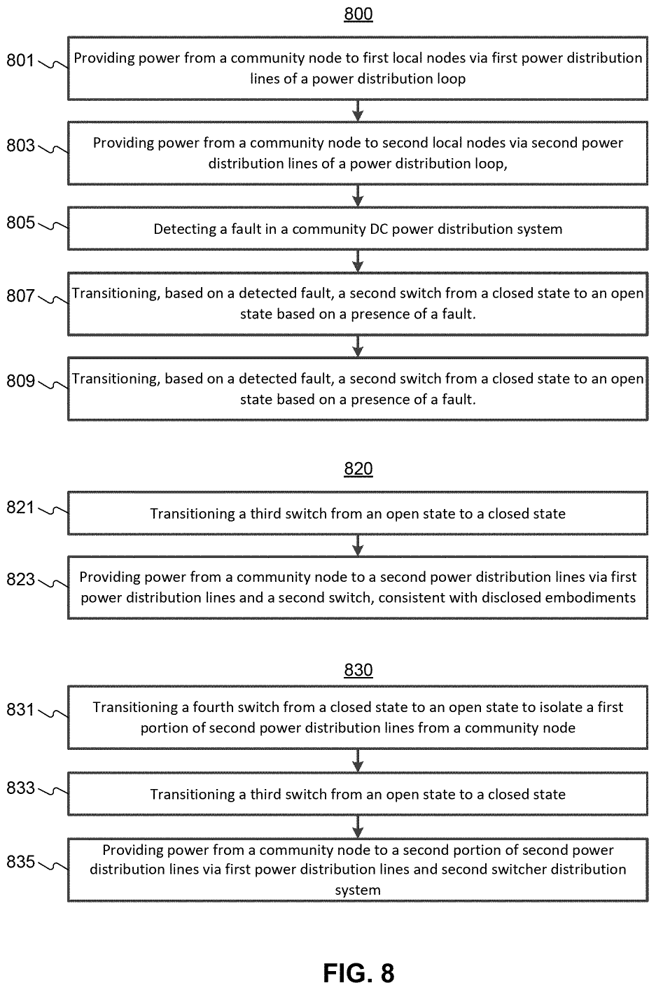

FIG. 8 depicts processes 800, 820, and 830 for handling faults in a community DC power distribution system, consistent with disclosed embodiments. Processes 820, and 830 may be extensions of process 800, in some embodiments. As will be apparent to one of skill in the art, steps of processes 800, 820, and 830 can be combined, rearranged, and/or performed in any order, consistent with disclosed embodiments. A community DC power distribution system used to implement processes 800, 820, and 830 can include a community node and a power distribution loop as depicted, for example, in FIG. 4 through 6C. In some embodiments, processes 800, 820, and 830 may involve community DC power distribution systems as depicted in FIGS. 4, 5A, 5B, 5C, 6A, 6B, and/or 7.

Processes 800, 820, and 830 can improve upon conventional methods for handling faults. Such conventional methods may attempt to distinguish faults from expected changes in current or voltage in a power distribution line arising from changes in loads. But conventional systems may poorly control or regulate current or voltage in power distribution lines. Accordingly, expected changes in current or voltage resulting from changes in loads may be substantial. For example, a substantial inrush current or voltage dip may accompany addition of a new load (e.g., starting of an electric motor). Because substantial changes in current or voltage may be expected, fault detection criteria in conventional systems may be permissive (e.g., current or voltage fault detection thresholds may permit substantial variation from nominal values, anomalous current or voltage values may only be deemed indicative of a fault after persisting for tens or hundreds of milliseconds, etc.) to prevent an unacceptable number of false alarms. Permissive fault detection criteria can allow faults to persist longer without detection and remediation than more stringent fault detection criteria, potentially allowing harm to people or animals and damage to equipment.

Disclosed embodiments may closely regulate the current and voltage of the power distribution lines. Changes in current or voltage in the power distribution lines may occur in a smooth and gradual manner, according to a protocol for exchanging power between the community node and another node (e.g., a local node or another community node). In some embodiments, such changes may depend on the current status of an energy storage device associated with the other node, not with the instantaneous power consumed by loads serviced by the community node or by the other node. Because the current and voltage of the power distribution lines are tightly controlled, stringent fault detection criteria may be imposed without causing an unacceptable number of false alarms. The stringent fault detection criteria may result in more rapid detection and remediation of faults, thereby preventing harm to people or animals or damage to equipment. Such methodologies may support fault detection (or fault detection and remediation, such as depowering a power line) within microseconds to milliseconds (e.g., 10 to 1000 microseconds, or preferably less than 500 microseconds), in contrast to conventional systems, which may require milliseconds to seconds (e.g., hundreds of milliseconds) to detect (or detect and remediate) a fault.

Referring to FIG. 8, at step 801, process 800 can include providing power from a community node to first local nodes via first power distribution lines of a power distribution loop, consistent with disclosed embodiments. First power distribution lines can be configured to be grounded through respective resistances of between 1 kOhm and 100 kOhm. In some embodiments, such resistances can be selected to approximate the DC resistance of dry intact human skin. As described herein, selecting such resistance values may improve the ability of the community DC power distribution system to detect faults arising from human contact with one or more of the first power distribution lines. In this manner, using grounding resistances with such resistance values may improve safety of the community DC power distribution system.

As previously described, the first power distribution lines can be configured to have a voltage difference of at least 380V (or, in some embodiments, at least 760V, at least 1520V, or at least 15,000V). The first power distribution lines can be electrically connected to the first switch, first local nodes, and a third switch. In some embodiments, providing power to first local nodes can include providing a current of least 400 amperes. In some embodiments, the first power distribution lines can be configured to capacitively store less than 10 Joules when providing power to the local nodes. Consistent with disclosed embodiments, the community DC power distribution system can be configured to establish a voltage difference between the first power distribution lines of 380V to 15,000V (e.g., at least 380V, at least 760V, at least 1520V, at least 1520V), or more. In some embodiments, the first power distribution lines can therefore be configured to capacitively store less than 10 Joules when a voltage difference of 380V to 15,000V (e.g., at least 380V, at least 760V, at least 1520V), or more, is established between them. Limiting the capacitive energy storage of the power distribution lines can enable the lines to be more rapidly and safely discharged in the event of a fault, improving the safety of the community DC power distribution system. As an example, step 801 can include providing power to first power distribution lines 407a connected to first local nodes 409a, first switch 403a, and third switch 411 (FIGS. 4, 5A, and 5B).

At step 803, process 800 can include providing power from the community node to second local nodes via second power distribution lines of the power distribution loop, consistent with disclosed embodiments. The second power distribution lines can be configured similar to the first power distribution lines. The second power distribution lines can be configured to be grounded through respective resistances of between 1 kOhm and 100 kOhm or any other range similar to the electrical resistance of dry intact human skin. As previously described, second power distribution lines can be configured to have a voltage difference of at least 380V (or, in some embodiments, at least 760V, at least 1520V, or at least 15,000V). Second power distribution lines can be electrically connected to a second switch, second local nodes, and a third switch. Providing power to second local nodes can include providing a current of at least 400 amperes. In some embodiments, of second power distribution lines can have a capacitive energy storage of less than 10 Joules when the first power distribution lines have a voltage difference of at least 380V (or, in some embodiments, at least 760V, at least 1520V, or at least 15,000V). As an example, step 803 can include providing power to second power distribution lines 407b connected to second local nodes 409b, second switch 403b, and third switch 411 (FIGS. 4, 5A, and 5B).

At step 805, process 800 can include detecting a fault in the community DC power distribution system, consistent with disclosed embodiments. In some embodiments, the fault can be associated with the second switch. For example, the switch may fail. There may be a fault in voltage, current, and/or a rate of change in voltage and/or current associated with the second switch or connected components. Alternatively or additionally, a fault may be associated with a power distribution line, a local node, and/or another component of a community DC power distribution system.

At step 807, process 800 may include transitioning, based on a detected fault, a second switch from a closed state to an open state based on a presence of the fault, consistent with disclosed embodiments. As an example, referring to FIG. 5A, second switch 403b may transition from a closed state in configuration 510 to an open state in configuration 530. As another example, second switch 403b may transition from a closed state in configuration 540 to an open state in configuration 550.

Further, at step 807, a third switch can be in an open state when the second switch transitions from a closed state to an open state, and transitioning the second switch from a closed state to an open state can isolate a portion of the second power distribution lines between the second switch and the third switch from the community node. As an illustration of step 807, FIG. 5C depicts switch 411b and switch 403a in closed states in configuration 570, and these switches may transition to open states in configuration 590 to isolate a portion of power lines 407a.

At step 809, a second switch can be electrically connected to third power distribution lines electrically connected to a fourth switch, and process 800 may include transitioning the fourth switch from an open state to a closed state to provide power from the community node to the third power distribution lines via the fourth switch. The third power distribution lines can be components of a power distribution loop, orphan power distribution lines, or components of another community DC power distribution system, consistent with disclosed embodiments.

As an illustration of step 809, FIG. 6B depicts first power distribution lines 607a, second power distribution lines 607b, and third power distribution lines 607c. Switch 611b may transition from a closed state in configuration 610 to an open state in configuration 620 to provide power from community node 613 to third power distribution lines 607c via switch 611b.

Third power distribution lines of step 809 can be configured to be grounded through respective resistances of between 1 kOhm and 100 kOhm or other resistance similar to the dc resistance of intact dry human skin. In some embodiments, third power distribution lines can be configured to have a voltage difference of at least 380V, at least 760V, at least 1520V, or at least 15,000V. In some embodiments, the third power distribution lines can be electrically connected to third local nodes.

Referring now to process 820, at step 821, process 820 may include transitioning a third switch from an open state to a closed state, consistent with disclosed embodiments. As an example, step 821 can be represented by a transition of switch 411 from an open state in configuration 510 to a closed state in configuration 520 (FIG. 5A).

At step 823, process 820 may include providing power from the community node to the second power distribution lines via the first power distribution lines and the second switch, consistent with disclosed embodiments. For example, as illustrated by thick dashed lines in configuration 520 (FIG. 5A), community node 413 provides power to second power distribution lines 407b via the first switch 403a, first power distribution lines 407a, and third switch 411.

Referring now to process 830, at step 831, second power distribution lines can be electrically connected to a fourth switch, and process 830 may include transitioning the fourth switch from a closed state to an open state to isolate a first portion of the second power distribution lines from the community node. As an example, step 830 can be represented by a transition of switch 411b from a closed state in configuration 570 to an open state in configuration 590 to isolate a portion 574 of power distribution lines 407a when switch 403a is also in an open state (FIG. 5C).

At step 833, process 830 may include transitioning a third switch from an open state to a closed state. Continuing the example from step 831, switch 411a may transition from an open state configuration 570 to a closed state in configuration 590 (FIG. 5C).

At step 835, process 830 may include providing power from the community node to the second portion of the second power distribution lines via the first switch, the first power distribution lines, and the third switch. Configuration 590 provides an illustrative of providing power (thick dashed lines) from community node 413 to portion 572 of the power distribution lines 407a via the switch 403b, the power distribution lines 407b, and switch 411a (FIG. 5C).

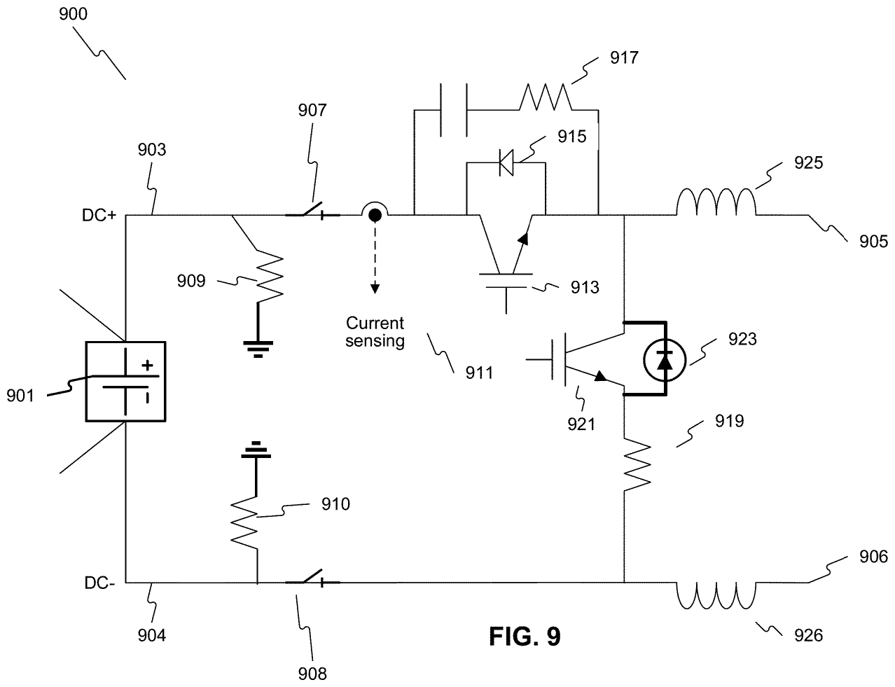

FIG. 9 depicts an exemplary schematic of a community node distributor 900, consistent with disclosed embodiments. A power distribution system can include such a community node distributor 900, which can be configured to applying a voltage source 901 to power distribution lines 903 and 904. In this non-limiting example, line 903 is a positive line and line 904 is a negative line (e.g., line 903 is positive with respect to line 904). One or more loads may be present at ends 905 and 906 (e.g., a plurality of local nodes). Switches 907 and 908 can be community node switches as previously described herein.

As shown lines 903 and 904 are grounded via resistors 909 and 910, respectively. Resistors 909 and 910 (e.g., “sensor resistors”) can have a resistance of between 1 kOhm and 100 kOhm, between 5 kOhm and 50 kOhm, or, more preferably, of between 5 kOhm and 20 kOhm, which are ranges similar to the typical dc resistance of dry intact human skin. Such sensor resistors may facilitate detecting ground fault events by enabling detection of voltage asymmetries with respect to ground between lines 903 and 904. Voltage source 901 can maintain a constant voltage of, for example, 380V between lines 903 and 904. During a ground fault event, such as contact between one of lines 903 or 905, the resistance to ground for the contacted line may decrease. Depending on the selected values of the sensor resistors and the resistance through the contact to ground, the overall resistance to ground for the contacted line may decrease by a factor of between 1 and 10. For example, when the resistance to ground through the contact equals the selected value of each of the sensor resistors, the overall resistance to ground for the contacted line may decrease by a factor of two. Thus, a ground fault may be detected by monitoring voltage asymmetries of the lines with respect to ground.

The disclosed embodiments are not limited to embodiments in which voltage asymmetries are detected. In some embodiments, the power distribution system can monitor the voltage differences between ground and one or more of lines 905 and 906. The power system can identify a fault when the such a voltage difference (or a change in such a voltage difference) satisfies a criterion (e.g., an absolute or proportional voltage threshold, an absolute or proportional change in voltage threshold, or any other function of the voltage difference that satisfies a thresholding criterion, machine learning criterion, or the like).

Distributor 900 can include a current sensing component 911 for monitoring changes in current and fluctuations in the rate of change of currents. Distributor 900 can further comprise switch 913, diode 915, and shunt 917 to protect switch 913 from transient voltages or currents during depowering of line 905. In some embodiments, distributor 900 includes a component bridging lines 905 and 906. This bridging component can include a switch 921 and a resistor 919, and diode 923 for protect switch 913 from transient voltages or currents during depowering of lines 905 and 906.

In some embodiments, lines 903 and 904 include inductors 925 and 926, respectively. Inductors 925 and 926 can be configured to limit a rate of change in the current (di I dt). As would be appreciated by those of skill in the art, a rate of change in the current (e.g., a maximum rate of change or average rate of change over a time interval) in lines 905 and 906 due to a fault may depend on a location of the fault. In general, this rate of change may increase with decreasing distance between the fault and the community node, due to the decrease in inductance of the lines between the fault and the community node. Without inductors 925 and 926, the power distribution system may be unable to detect the change and take appropriate corrective action before a fault occurring near the community node causes harm to individuals or damage to equipment. Inductors 925 and 926 may limit the rate of change in the current to an acceptable value that affords the power distribution system the time to detect the change and take appropriate corrective action. In some embodiments, the inductors can be sized to enable detection times for faults of about 10 to 500 microseconds and a current capacity of about 800 A for a 400 A nominal current.

As would be appreciated by those of skill in the art, the particular arrangement of parts in FIG. 9 is not intended to be limiting. For example, each of resistors 909 and 910 (e.g., the “sensor resistors”) can be electrically connected anywhere between the positive and negative terminals of voltage source 901 and the respective originations of lines 905 or 906. The electrical connections made by these resistors need not be symmetric. Likewise, each of switches 907 and 908 can be electrically connected anywhere between the positive and negative terminals of voltage source 901 and the respective originations of lines 905 or 906.

In some embodiments, switch 907 can be combined with or include one or more other components of FIG. 9, such as resistor 909, current sensor 911, shunt 917, diode 915, switch 913, inductor 925, switch 921, diode 923, or resistor 919. For example, switch 907 can include shunt 917, diode 915, and switch 913. In such embodiments, opening switch 913 can constitute or be part of opening switch 907. As a further example, switch 907 can include resistor 919, diode 923, and switch 921.

In some embodiments, switch 907 and switch 908 can be part of a single element. For example, switch 907 and switch 908 can be part of a single mechanical or solid-state switch, or an assembly of mechanical or solid-state switches acting as a single element.

In some embodiments, additional elements respectively similar to current sensor 911, shunt 917, diode 915, and switch 913 can be interposed between the negative terminal of voltage source 901 and line 906. In some such embodiments, switch 908 can be combined with or include one or more of these additional components.

FIG. 10 depicts system 1000 for enabling power exchange between community DC power distribution systems, consistent with disclosed embodiments. As shown, community DC power distribution systems 1001 and 1003 are connected via connector 1005. Systems 1001 and 1003 can be or include any DC power distribution systems as disclosed herein. Connector 1005 can include switches, smart interface controllers, and/or other components for facilitating power transfer between community DC power distribution systems as disclosed herein.

Although FIG. 10 depicts community DC power distribution systems 1001 and 1003 as having a power distribution loop and two community node switches (e.g., as in the embodiments of FIGS. 4 through 5C), system 1000 is not limited to such topologies or configurations. System 1000 can include community DC power distribution systems 1001 and 1003 with clover leaf topologies, for example, and/or any other topology (e.g., any example of FIG. 7). Further, although community DC power distribution systems 1001 and 1003 are depicted as being connected via power distribution loops, they can be connected via orphan power distribution lines, in some embodiments. In addition, more than two DC power distribution systems can be connected via connector 1005.

Backup Control for Power System Management

The disclosed embodiments can be configured to support continuous operation of a power system when a primary controller fails or is compromised or corrupted, or when communications between the primary controller and the power system are interrupted. Consistent with disclosed embodiments, a backup controller can then manage the power system. In some embodiments, as compared to the primary controller, the backup controller may exhibit less flexibility or sophistication in managing the components of the power system. However, the backup controller can be configured to ensure the correct operation and health of the components of the power system (e.g., any energy storage components, such as batteries). The backup controller can be implemented by a control device not configured to accept configuration by computing devices outside the power system. For example, in some embodiments, the backup controller may not be programmed, reset, disabled, or altered using external communications networks connected to the primary controller or internal communications networks connecting the components of the power system. Accordingly, the backup controller may be resilient against attempts to corrupt or compromise the power system. In some embodiments, the backup controller can be implemented using a digital platform enabler (e.g. DPE) configured to maintain an internal network connecting the components of the power system. In various embodiments, this DPE can be configured to decode signals received from an external power source on a power bus connected to the power system.

During normal operation, the primary controller can communicate with components of the power system using the DPE. The DPE may not be executing any control; instead, it may decode signals from the external (or internal power bus) and pass these signals to the primary controller. The DPE can, however, monitor communications between the primary controller and other components in the system (e.g., energy storage components such as batteries). The DPE can be configured with rules, settings, actions, and operating ranges that are normal set points and states commanded by the primary controller. If the requests from primary controller are outside the normal parameter ranges preprogrammed in the DPE or any component is commanded to execute an abnormal action, the DPE can be configured to determine (e.g., using a diagnostic program or heuristic) whether the primary controller is failing, compromised, or corrupted. In response to a determination that the primary controller is failing, compromised, or corrupted, the DPE can physically disconnect the primary controller from the rest of the system and initiate operation under a backup mode. In the backup mode, the DPE can become the master of the internal network and can execute simple control algorithms to ensure safe operation of the power system.

In some embodiments, the conditions triggering the entry into backup mode can be updated by interfacing directly with the DPE. In this manner, the conditions that can initiate the backup mode can evolve and be enhanced in response to a changing threat environment. In some embodiments, after entering backup mode, the DPE can continue to receive requests from the primary controller until a reset condition is satisfied. In some embodiments, upon satisfaction of the reset condition, the DPE can automatically return to a normal operation mode.

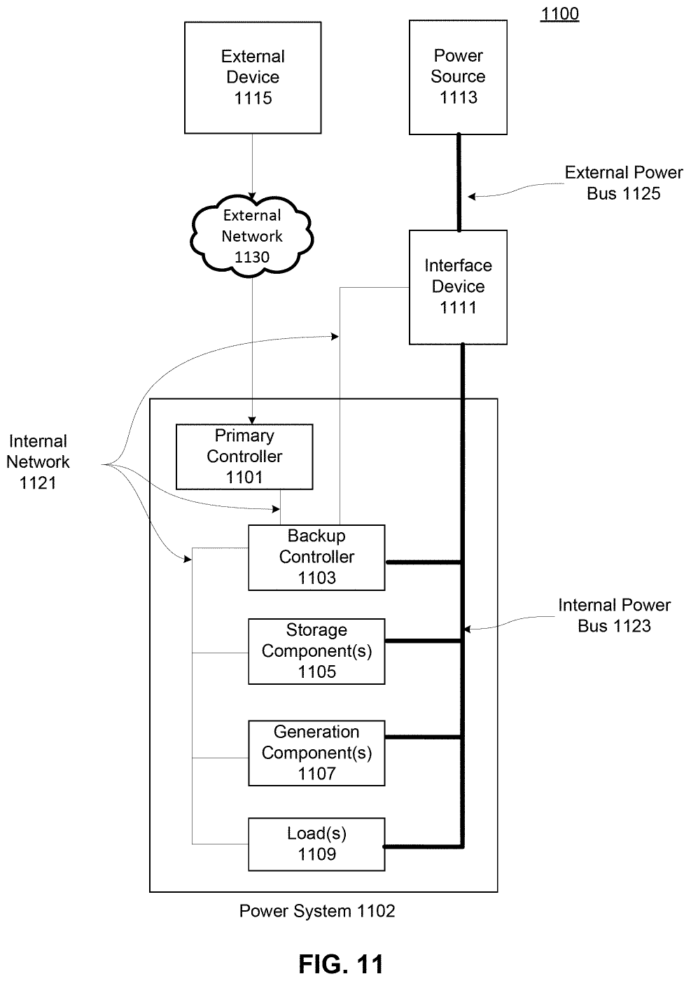

FIG. 11 depicts an exemplary power system 1102, consistent with disclosed embodiments. Power system 1102 can include at least one of storage component(s) 1105, generation component(s) 1107, or load(s) 1109. Power system 1102 can be configured to receive power through interface controller 1111 from power source 1113. Power system 1102 can be controlled by primary controller 1101 and a backup controller 1103. Primary controller 1101 can be configured to enable coordination with other systems, updating and reconfiguration of power system 1102, and improved control through use of external information. Backup controller 1103 can be configured to assume control of power system 1102 in case of failure or compromise of primary controller 1101. The flexibility, control, and security of power system 1102 is therefore improved through the use of primary controller 1101 and backup controller 1103, consistent with disclosed embodiments.

Primary controller 1101 can be configured to manage power system 1102, consistent with disclosed embodiments. In some embodiments, managing power system 1102 can include maintaining a state of power system 1102 within desired bounds. The state of power system 1102 can include a set of variables describing the operation of power system 1102. For example, the voltage or current within internal power bus 1123; the energy stored or provided by storage component(s) 1105, produced by generation component(s) 1107, or consumed by load(s) 1109; the status of one or more components of power system 1102 (e.g., the temperature of a battery, the open/closed state of a relay, or the like); predicted future production and consumption values of the power system; or the like. The particular values included in the state may depend on the specific configuration of power system 1102 and the disclosed embodiments are not limited to a particular collection or representation of the state. Likewise, the disclosed embodiments are not limited to particular bounds on the state. Exemplary bounds may include maintaining internal power bus 1123 at a voltage amplitude or within a voltage amplitude range; minimizing the cost of providing power to load(s) 1109; extending the lifetime of one or more components of power system 1102 (e.g., storage component(s) 1105); or maintaining the energy stored by storage component(s) 1105 within a predetermined range of values.

Primary controller 1101 can be configured to communicate with components of power system 1102 and with interface controller 1111 using internal network 1121, consistent with disclosed embodiments. Primary controller 1101 can be configured to communicate using internal network 1121 with backup controller 1103, which can be configured to transfer, translate, or relay communications between primary controller 1101 and components of power system 1102, or between primary controller 1101 and interface controller 1111. In some embodiments, the communications can include instructions provided to components of power system 1102 or to interface controller 1111. The instructions, when executed by the components of power system 1102 or interface controller 1111, can configure power system 1102 to accommodate variations in power generation and demand over a variety of timescales, ranging from seconds to months. For example, primary controller 1101 can be configured to provide instructions to generation component(s) 1107 to start or stop power generation, to load(s) 1109 to shed or reschedule operations, to storage component(s) 1105 to store or provide power, or to interface controller 1111 to set or request a magnitude or direction of power transfer. As detailed herein, such instructions can be provided through backup controller 1103.

Primary controller 1101 can be configured to communicate over external network 1130 with other computing devices (e.g., external device 1115), consistent with disclosed embodiments. Such communications can be used to coordinate the operation of primary controller 1101 with other systems, reconfigure the operation of primary controller 1101, improve the control of power system 1102, or the like. For example, a computing device (e.g., external device 1115) can provide instructions to coordinate power generation and demand to multiple power systems including power system 1102 using external network 1130. As an additional example, primary controller 1101 can be updated remotely with new control algorithms or additional functionalities (or have existing functionalities disabled or removed) using instructions provided through external network 1130. As a further example, primary controller 1101 can obtain information for managing power system 1102 through external network 1130. Such information can include information for predicting power production or consumption (e.g., weather reports, historical demand, or generation information) or pricing information (e.g., the current or predicted cost of power).

Backup controller 1103 can be connected to the power system 1102 and the interface controller 1111 through an internal network 1121, consistent with disclosed embodiments. Backup controller 1103 can be configured with at least two modes. In a monitoring mode, backup controller 1103 can provide an interface between primary controller 1101 and both interface controller 1111 and power system 1102. For example, backup controller 1103 can be configured to transfer, translate, or relay communications between primary controller 1101 and components of power system 1102, or between primary controller 1101 and interface controller 1111. In some embodiments, when in monitoring mode, backup controller 1103 can monitor the operation of primary controller 1101 or estimate a state of power system 1102. For example, backup controller 1103 can monitor the frequency and content of communications between primary controller 1101 and components of power system 1102, or between primary controller 1101 and interface controller 1111. As a further example, backup controller 1103 can estimate, based on the monitored communications, the state of power system 1102. In some embodiments, when in monitoring mode, backup controller 1103 can be configured to determine that an abnormal operation condition has been satisfied. This determination can be based on the estimated state of power system 1102; or the frequency or content of communications between primary controller 1101 and power system 1102 or interface controller 1111. In response to this determination, backup controller 1103 can be configured to switch to a backup operation mode. As a non-limiting example, backup controller 1103 can switch to the backup operation mode when triggered by predetermined inputs.

In backup operation mode, backup controller 1103 can isolate primary controller 1101 from power system 1102 and interface controller 1111, consistent with disclosed embodiments. Backup controller 1103 can isolate primary controller 1101 from power system 1102 by disabling communication between primary controller 1101 and power system 1102. For example, backup controller 1103 can be configured to physically disconnect primary controller 1101 from power system 1102. Primary controller 1101 can be physically disconnected using a mechanical or electrical switch (e.g., a solid-state switch or multiplexor), or other suitable method. As an additional example, backup controller 1103 can be configured to cease relaying messages between primary controller 1101 and power system 1102 or interface controller 1111. The details of ceasing such relaying may depend on the message protocol used for communication over the internal network and are not intended to be limiting. As a non-limiting example, backup controller 1103 may receive and forward messages received from primary controller 1101 in a normal operation mode, but may cease forwarding such messages in backup mode. Backup controller 1103 can similarly isolate primary controller 1101 from interface controller 1111.

In backup operation mode, backup controller 1103 can control power system 1102 and interface controller 1111, consistent with disclosed embodiments. Backup controller 1103 can be configured to seamlessly assume control of power system 1102. For example, backup controller 1103 can control power system 1102 based on the currently estimated state of power system 1102 (e.g., obtained by monitoring communications between power system 1102 and primary controller 1101), rather than causing power system 1102 to enter a predetermined state (e.g., a default state, reset state, rebooted state, or the like). In some embodiments, as described herein, backup controller 1103 can be configured to manage power system 1102 based on a control value determined from at least one of a power transfer rate of storage component(s) 1105, state of energy storage of the storage component, or power boundary value.

In some embodiments, backup controller 1103 can be configurable, but not configurable using external network 1130. For example, backup controller 1103 may not be connected to external network 1130. As an additional example, backup controller 1103 may be configured to discard, ignore, or reject messages not originating in either power system 1102 or interface controller 1111. Additionally or alternatively, backup controller 1103 can be configurable, but not configurable using internal network 1121. In some embodiments, backup controller 1103 may only accept configuration instructions (e.g., firmware updates, control algorithms, device setting or parameters, or the like) provided using an interface unconnected to external network 1130 or internal network 1121. Such an interface can be a communication interface (e.g., an RS-232 connector or ethernet jack) or user interface (a graphical user interface, keyboard, jumper, mechanical interface, or other suitable interface) provided by a device implementing backup controller 1103.

Primary controller 1101 and backup controller 1103 can be implemented using one or more computers, embedded microcontrollers, or the like. In some embodiments, primary controller 1101 and backup controller 1103 can be implemented in the same device. In various embodiments, primary controller 1101 and backup controller 1103 can be implemented in separate devices.

Storage component(s) 1105 can be configured to store power from or provide power to internal power bus 1123, consistent with disclosed embodiments. Storage component(s) 1105 can include at least one of an electrical (e.g. capacitive, or the like), electrochemical (e.g., battery or the like), mechanical (e.g., flywheel, compressed or liquid air, or the like), hydroelectric (e.g., pumped storage or the like), or similar energy storage system. In some embodiments, storage component(s) 1105 can be configured to sink or source direct current at a voltage. In some embodiments, storage component(s) 1105 can be directly connected to internal power bus 1123. For example, the storage device can be one or more batteries having terminals connected directly to the power grid. In such embodiments, a voltage of internal power bus 1123 can be automatically maintained at a setpoint determined by the storage component(s) 1105. For example, when the terminals of the one or more batteries are directly connected to internal power bus 1123, the voltage of internal power bus 1123 can automatically depend on a state of charge of the battery, without requiring additional hardware or software. In various embodiments, the storage component can be indirectly connected to internal power bus 1123. For example, a converter (such as a DC/DC convertor or power inverter) can be placed between storage component(s) 1105 and internal power bus 1123. The converter can be configured to sink or source power from storage component(s) 1105 as necessary to maintain a voltage of internal power bus 1123 at a setpoint or within a range (e.g., a predetermined setpoint or range).

Generation component(s) 1107 can be configured to provide power to internal power bus 1123, consistent with disclosed embodiments. Generation component(s) 1107 can include different types of power generation components. Different types of power generation components may have different characteristics, such as response time, minimum and maximum power supply-able, or marginal costs of generation. Furthermore, different types of power generation components may have different fuel costs. For example, solar power plants (e.g. photovoltaic or solar thermal), wind power plants (e.g., wind turbines), or hydroelectric power plants, may have low margin generation costs and no (or negligible) fuel costs. As a further example, gas peaker plants may have fast response times and higher marginal costs of generation. Other possible generation components may be suited to baseload power generation, such as coal or nuclear power plants. In some embodiments, generation component(s) 1107 can be configured to automatically start or stop generation in response to instructions received from primary controller 1101 or backup controller 1103. In various embodiments, primary controller 1101 or backup controller 1103 can provide instructions for manually starting or stopping generation component(s) 1107.

Load(s) 1109 can be configured to draw power from internal power bus 1123, consistent with disclosed embodiments. Load(s) 1109 can include different types of loads. In some embodiments, whether load(s) 1109 draw power from internal power bus 1123 can be controlled automatically (or manually in response to provided instructions) by primary controller 1101 or backup controller 1103. For example, one of load(s) 1109 can be connected or disconnected from internal power bus 1123. As a further example, in some embodiments, the load can be instructed to draw less power, or the operation of the load can be rescheduled. For example, primary controller 1101 or backup controller 1103 can provide instructions to turn off or reschedule operation of an air conditioning unit or turn off external lights on a dwelling.

Interface controller 1111 can be configured to determine a magnitude and direction of power transfer between external power bus 1125 and internal power bus 1123. Interface controller 1111 can be implemented in a single device with one or more of primary controller 1101 or backup controller 1103; or implemented in a separate device. Interface controller 1111 can be or include an adjustable bi-directional current source. In some embodiments, interface controller 1111 can be configured to determine the magnitude and direction of power transfer according to instructions received from primary controller 1101 or backup controller 1103. For example, primary controller 1101 can instruct a magnitude and direction of power transfer and interface controller 1111 can implement the instructed magnitude and direction of power transfer. In various embodiments, interface controller 1111 can be configured to determine the magnitude and direction of power transfer based on requests received from primary controller 1101 (or backup controller 1103) and from another device or system (e.g., power source 1113). For example, interface controller 1111 can receive a request from primary controller 1101 to provide a first amount of power (e.g., when storage component(s) 1105 are at capacity) and a request from power source 1113 to provide a second power. Interface controller 1111 can then determine resulting magnitude and direction of power transfer based on the first and second amounts (and optionally weights or priorities associated with each of power system 1102 and power source 1113). In some embodiments, interface controller 1111 can include a power convertor, such as a transformer, AC/DC convertor, or DC/DC convertor. The power convertor can be configured to covert from a voltage or transmission type of external power bus 1125 to a voltage or transmission type of internal power bus 1123.

In some embodiments, interface controller 1111 can be configured to decode communications provided by power source 1113 using external power bus 1125. For example, power source 1113 can encode information concerning the state of power source 1113 into fluctuations in the power conveyed by external power bus 1125. In a non-limiting example, such fluctuations can be implemented using changes in the voltage of external power bus 1125. In some embodiments, the communications can be encoded into the external power bus using multiplexing (e.g., time division multiplexing, code division multiplexing, or another suitable method). In various embodiments, the communications can be encrypted or obfuscated. Decoding the communications can include converting the fluctuations to instructions, with or without decrypting or de-obfuscating the instructions, depending on the implementation of the communications. In some embodiments, interface controller 1111 can be configured to provide the decoded communications to backup controller 1103. In various embodiments, interface controller 1111 can be configured to pass the fluctuations from the external power bus to the internal power bus, where they can be detected and decoded by backup controller 1103.

Power source 1113 can be configured to provide power to external power bus 1125, consistent with disclosed embodiments. Power source 1113 can be another power system, similar to power system 1102. For example, when power system 1102 is a microgrid associated with one or more homes or businesses, power source 1113 can be a community grid associated with a geographic region or political entity encompassing the homes or businesses. Power source 1113 can include generators or storage devices to provide power. In some embodiments, power source 1113 can be managed independently from power system 1102 or interface controller 1111. In various embodiments, power source 1113 can be configured to interact with interface controller 1111 to affect the transfer of power between external power bus 1125 and internal power bus 1123. For example, power source 1113 can provide a power transfer request to interface controller 1111; interface controller 1111 can then determine the power transfer between external power bus 1125 and internal power bus 1123 based, at least in part, on this power transfer request.

External device 1115 can be configured to provide instructions or information to primary controller 1101. For example, external device 1115 can be, or be part of, a system configured to control or coordinate multiple power systems including power system 1102. This system can be a hierarchical system. For example, external device 1115 can be configured to enforce conditions on the overall system (e.g., conditions on system power generation, system renewable or non-renewable energy generation, system power consumption, system operating cost, or the like) by providing instructions to controllers of individual power systems (e.g., power system 1102).

In some embodiments, external device 1115 can be used to configure primary controller 1101. For example, external device 1115 can be configured to provide software or firmware updates to primary controller 1101, update control algorithms used by primary controller 1101, or change device settings or parameters of primary controller 1101.

In various embodiments, external device 1115 can provide information used by primary controller 1101 to manage power system 1102. For example, external device 1115 can provide weather forecasts; or historical power generation, consumption, or pricing data. In some embodiments, primary controller 1101 can provide information to external device 1115, such as power generation or consumption information.

Internal network 1121 can be one or more communication networks configured to enable communication between primary controller 1101 (or backup controller 1103) and power system 1102 (e.g., between a controller and storage component(s) 1105, generator component(s) 107, or load(s) 109) or interface controller 1111. In some embodiments, internal network 1121 can be configured to support a suitable building automation or industrial automation communication protocol. For example, internal network 1121 can be configured to support communications between a controller and another device using CANBUS, MODBUS RTU, MODBUS TCP-IP, or a similar protocol. In some embodiments, internal network 1121 can be configured to support serial communication (e.g., RS-232, RS-485, ethernet, or similar standards or protocols). In some embodiments, primary controller 1101 can serve as the master in a master/slave framework on internal network 1121 when backup controller 1103 is in the normal operation mode, and backup controller 1103 can assume the master role in internal network 1121 when backup controller 1103 is operating in backup mode. However, the disclosed embodiments are not intended to be limited to any particular network topology or implementation.

Internal power bus 1123 can include one or more devices for supplying power to components of power system 1102 (e.g., a conductor, busbar, or the like), consistent with disclosed embodiments. Internal power bus 1123 can be electrically connected to the components of power system 1102 and to interface controller 1111. As described above with regards to storage component(s) 1105, internal power bus 1123 can be directly or indirectly connected to storage component(s) 1105. When internal power bus 1123 is directly connected to storage component(s) 1105, then the voltage of internal power bus 1123 can be determined by a status of storage component(s) 1105 (e.g., in embodiments where storage component (s) 105 includes a battery directly connected to internal power bus 1123, a state of charge of the battery). In some embodiments, internal power bus 1123 can be implemented using direct current. In various embodiments, internal power bus 1123 can be implemented using alternating current.

External power bus 1125 can include one or more devices for transferring power between power source 1113 and interface controller 1111 (e.g., transmission lines, or the like), consistent with disclosed embodiments. In some embodiments, internal power bus 1123 can be implemented using direct current. In various embodiments, internal power bus 1123 can be implemented using alternating current.

External network 1130 can be any type of network that supports communications between primary controller 1101 and remote computing devices (e.g., external device 1115). External network 1130 can be a wireless network, a wired network, or a network combining wired and wireless links (e.g., a cellular network connecting to a wired packet-switched network, or a WIFI network connected to a wired network through a wireless access point).

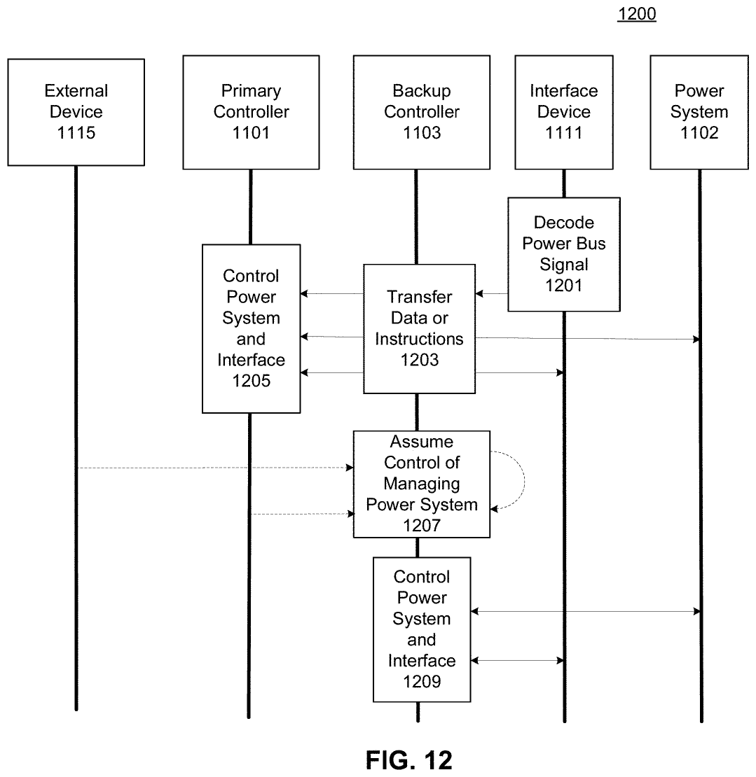

FIG. 12 depicts an exemplary method 1200 for switching control of a power system between controllers, consistent with disclosed embodiments. As depicted in FIG. 12, backup controller 1103 can be configured to pass information received from interface controller 1111 and components of power system 1102 (depicted as “power system 1102” in FIG. 12) to primary controller 1101. Primary controller 1101 can control power system 1102 by providing instructions to interface controller 1111 and the components of power system 1102. In response to satisfaction of a condition, backup controller 1103 can enter a backup mode and assume control of managing power system 1102. Backup controller 1103 can then control power system 1102 by providing instructions to interface controller 1111 and the components of power system 1102.

In step 1201 of method 1200, interface controller 1111 can be configured to decode information encoded into an external power signal. The information can be encoded into fluctuations in the power provided by external power bus 1125 (e.g., encoded into fluctuations in the voltage, such as fluctuations in the amplitude of the voltage). Interface controller 1111 can be configured to decode the signals, as described herein, and provide the decoded signals to a controller (e.g., primary controller 1101 or backup controller 1103, depending on the mode of backup controller 1103). In some embodiments, interface controller 1111 can be configured to provide the decoded signals using internal network 1121. In some embodiments, interface controller 1111 can be configured to provide the decoded signals directly to primary controller 1101 (e.g., using another network separate from internal network 1121 or a link of internal network 1121 that directly connects interface controller 1111 and primary controller 1101). In various embodiments, interface controller 1111 can convert the fluctuations into data and pass the data to the controller, which can decrypt or de-obfuscate the data for use in controlling power system 1102.

The disclosed embodiments are not limited to embodiments in which decoding is performed by interface controller 1111. As described herein, in some embodiments, backup controller 1103 can be configured to perform the decoding using fluctuations on communicated through interface controller 1111 from external power bus 1125 to internal power bus 1123.

In step 1203 of method 1200, backup controller 1103 can be configured to transfer data or instructions between primary controller 1101 and interface controller 1111 or power system 1102. In some embodiments, backup controller 1103 can be configured to permit communication between primary controller 1101 and power system 1102. For example, backup controller 1103 can be configured to receive data from interface controller 1111 and components of power system 1102. The data can include information decoded from a signal on external power bus 1125 (or, in some embodiments, internal power bus 1123), status information concerning storage component(s) 1105, generation component(s) 1107, load(s) 1109, or similar data concerning power system 1102. Backup controller 1103 can be configured to pass such information to primary controller 1101. The information can be provided to primary controller 1101 using internal network 1121. As a further example, backup controller 1103 can also be configured to receive instructions from primary controller 1101. In various embodiments, backup controller 1103 can be configured to transfer, translate, or relay these instructions to components of power system 1102 or interface controller 1111. In some embodiments, backup controller 1103 can be configured to monitor communications between primary controller 1101 and interface controller 1111 or components of power system 1102 to estimate a state of power system 1102. For example, backup controller can track the reported statuses, settings, configurations, or the like of interface controller 1111 and components of power system 1102 to estimate the state of power system 1102.

While step 1203 is depicted as occurring after step 1201, this depiction is not intended to be limiting. In some embodiments, backup controller 1103 can be configured to receive information decoded from signals in external power bus 1125 before, after, or during receipt of information from components of power system 1102.

In step 1205, primary controller 1101 can be configured to control power system 1102 and interface controller 1111 based on the data or instructions received from backup controller 1103. For example, primary controller 1101 can be configured to provide instructions to start or stop power generation by generation component(s) 1107 (or selected ones of generation component(s) 1107); assume or shed loads by starting, stopping, modifying, or rescheduling operations of load(s) 1109 (or selected ones of load(s) 1109); configure storage component(s) 1105 to store or provide power to internal power bus 1123, or other suitable instructions. As a further example, primary controller 1101 can be configured to communicate with interface controller 1111 to set a power transfer value between external power bus 1125 and internal power bus 1123. This power transfer value can include a magnitude of power transfer and a direction of power transfer. These instructions can be transferred, translated, or relayed through backup controller 1103 to their respective destinations on internal network 1121.

In step 1207, backup controller 1103 can be configured to assume control of power system 1102 and interface controller 1111. Backup controller 1103 assume control of power system 1102 and interface controller 1111 in response to a determination, by backup controller 1103, that an abnormal operation condition has been satisfied.

In some embodiments, backup controller 1103 can determine that the abnormal operation condition has been satisfied by an input received from another device. The input can be a control signal (e.g., a high value on a reset line) or an instruction (e.g., a command to transfer backup controller 1103 into backup mode). The device can be authorized to transfer backup controller 1103 into backup mode. The device can be primary controller 1101 or external device 1115. In some embodiments, configuring backup controller 1103 may not include transferring backup controller 1103 into backup mode. Configuration of backup controller 1103 may not be permitted through external network 1130 or internal network 1121, while transferring backup controller 1103 into backup mode may be permitted. In various embodiments, configuring backup controller 1103 may include transferring backup controller 1103 into backup mode. In such embodiments, the input signaling the abnormal condition can be received from another device through an input to backup controller 1103 physically or logically separate from the internal communication network or the external communication network.

In some embodiments, backup controller 1103 can determine that the abnormal operation condition has been satisfied when primary controller 1101 appears to fail. For example, backup controller 1103 can determine that the abnormal operation condition has been satisfied when primary controller 1101 ceases communicating (e.g., ceasing to provide instructions or ceasing to request or otherwise access information from components of power system 1102 or interface controller 1111) with components of power system 1102 or interface controller 1111 for a predetermined time (e.g., a time between 10 seconds and 1,000 seconds). In some embodiments, backup controller 1103 can determine that the abnormal operation condition has been satisfied when primary controller 1101 stops providing a heartbeat signal.

In some embodiments, backup controller 1103 can determine that the abnormal operation condition has been satisfied when backup controller 1103 determines, based on monitored communications between primary controller 1101 and components of power system 1102, that power system 1102 has reached an abnormal state (e.g., backup controller 1103 can trigger itself—indicated in FIG. 12 by the arrow circling from 207 to 207). For example, backup controller 1103 can determine that a level of stored energy, rate of power transfer, or temperature of power storage component(s) 1105 satisfies an abnormal state condition (e.g., when power storage component(s) 1105 comprises a battery, an excessively high or low state of charge, excessively high charge or discharge rate, or excessively high temperature). As an additional example, backup controller 1103 can determine that all of load(s) 1109 have been disconnected. As a further example, backup controller 1103 can determine that all generation component(s) 1107 have been instructed to start providing power when such power is not required, based on the current status of storage component(s) 1105.

In some embodiments, backup controller 1103 can determine that the abnormal operation condition has been satisfied when backup controller 1103 determines, based on monitored communications between primary controller 1101 and components of power system 1102, that primary controller 1101 has provided a command to power system 1102 that would result the failure or abnormal operation of power system 1102 (e.g., backup controller 1103 can trigger itself—indicated in FIG. 12 by the arrow circling from 207 to 207). For example, the command, if provided by backup controller to the intended recipient component of power system 1102, would cause the intended recipient component to malfunction or otherwise behave in a manner contrary to the intended design and operation of power system 1102.

Backup controller 1103 can be configured to assume control of power system 1102 and interface controller 1111 by switching to a backup mode, consistent with disclosed embodiments. In the backup mode, the backup controller 1103 can be configured to disable communication between primary controller 1101 and power system 1102 or interface controller 1111. In some embodiments, disabling communication between primary controller 1101 and power system 1102 can include physically disconnecting primary controller 1101 from power system 1102 (e.g., using a mechanical or electronic switch). In various embodiments, disabling communication between the primary controller 1101 and power system 1102 can include ceasing relaying messages between the primary controller 1101 and power system 1102.

In step 1209, after switching to backup mode, backup controller 1103 can be configured to control power system 1102 and interface controller 1111 based on received data or instructions, consistent with disclosed embodiments. In some embodiments, backup controller 1103 can be configured to control power system 1102 by communicating with interface controller 1111 to set a power transfer value. In some embodiments, backup controller 1103 can communicate with interface controller 1111 by providing a request to transfer power between the external power bus 1125 and the internal power bus 1123 based on the power transfer value. The power transfer value can have a magnitude and direction. The request includes instructions that, when executed by the interface device, configure to the interface device to transfer power between external power bus 1125 and internal power bus 1123 based on the power transfer value. In various embodiments, backup controller 1103 can be configured to control power system 1102 by communicating with storage component(s) 1105, generation component(s) 1107, and load(s) 1109 to manage the provision and consumption or storage of power by power system 1102. For example, backup controller 1103 can be configured to manage power transfer to internal power bus 1123 by a generator component or photovoltaic component of power system 1102 based on a control value determined by backup controller 1103, as described herein.

In some embodiments, backup controller 1103 can be configured to exit backup mode in response to satisfaction of a reset condition. In some embodiments, backup controller 1103 can be configured to determine that the reset condition has been satisfied. Backup controller 1103 can determine that the reset condition is satisfied in response to receipt of an input from another device. Similar to receipt of an input signaling abnormal operations, the input can be a control signal or instruction; can be received from external device 1115 or primary controller 1101; or can be received using an input to backup controller 1103 physically or logically separate from the internal communication network or the external communication network. Such an input can be distinct from the input used to signal occurrence of the abnormal condition. In some embodiments, backup controller 1103 can determine that the reset condition has been satisfied when primary controller 1101 appears to resume operation (e.g., by resuming attempts to communicate with power system 1102 or interface controller 1111, resumption of a heartbeat signal, or the like). In some embodiments, backup controller 1103 can determine that the reset condition has been satisfied when backup controller 1103 determines, based on communications with components of power system 1102, that power system 1102 is no longer in an abnormal state.

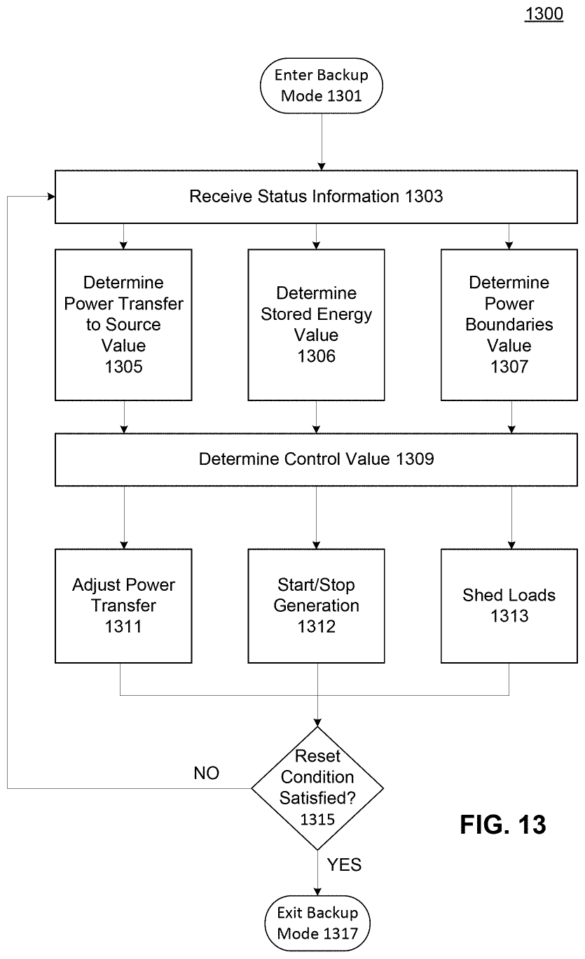

FIG. 13 depicts an exemplary method 1300 for controlling power system 1102, consistent with disclosed embodiments. Consistent with method 1300, backup controller 1103 can receive information from components of power system 1102 and determine, based on the received information, one or more of a stored energy value, power transfer value, or power boundary value based on the stored information. Backup controller 1103 can then determine a control value based on the one or more of the stored energy value, power transfer value, or power boundary value. In some embodiments, the control value can represent the present power or energy needs for the power system 1102. Backup controller 1103 can manage power system 1102 based on the control value.

Backup controller 1103 can repeatedly determine the control value, consistent with disclosed embodiments. In some embodiments, backup controller 1103 can determine the control value periodically. The period between determination of successive control values can depend on the characteristics of storage component(s) 1105 or the bandwidth of external power bus 1125 for communicating information (e.g., the higher the bandwidth the shorter the period). In some embodiments, the period between determination of successive control values can range from 5 to 1000 seconds. In various embodiments, backup controller 1103 can be configured to update the control value in response to satisfaction of a condition concerning power system 1102 (e.g., starting or stopping generator component(s) 107, stored energy values outside a predetermined range, or the like).

In step 1301 of method 1300, backup controller 1103 can be configured to enter backup mode. As described above, with regards to FIG. 12, backup controller 1103 can be configured to enter backup mode when an abnormal operation condition is satisfied.

In step 1303 of method 1300, backup controller 1103 can be configured to receive status information from power system 1102 and interface controller 1111. Such information can include status information for storage component(s) 1105, generation component(s) 1107, or load(s) 1109. In some embodiments, status information for storage component(s) 1105 can include the amount of energy stored, power transfer to or from storage component(s) 1105, or performance or safety information for storage component(s) 1105 (e.g., turbine speed for a gas generator, battery temperature for a battery, or similar information). This information can be received using internal network 1121.

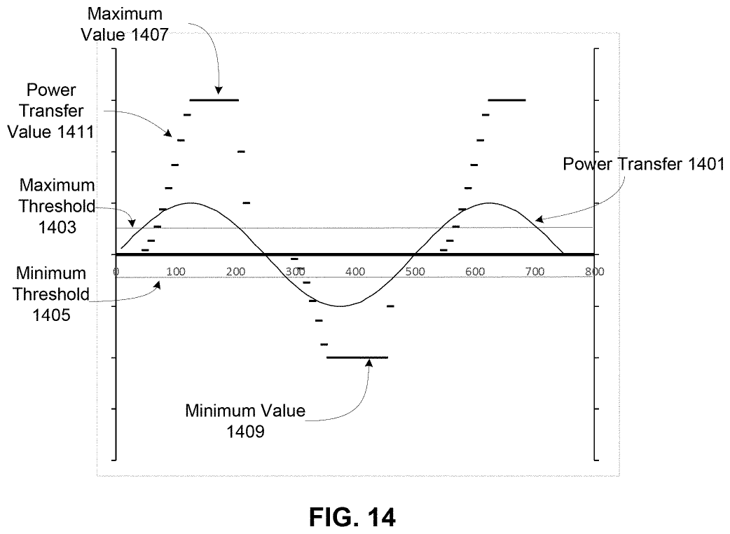

In step 1305 of method 1300, backup controller 1103 can be configured to determine a power transfer value consistent with disclosed embodiments. The power transfer value can be constructed to reduce the possibility of a rate of energy storage or discharge sufficient to damage storage component(s) 1105. The power transfer value can be determined according to a formula including a safe zone. The power transfer value can remain unchanged while the charging or discharging rate falls within the safe zone. When the charging rate exceeds maximum safe charging value, the power transfer value can increase towards a maximum value. When the discharging rate exceeds a maximum safe discharge rate, the power transfer value can decrease towards a minimum value. FIG. 14 provides an example of determining a power transfer value.

In step 1305 of method 1300, backup controller 1103 can be configured to determine a power transfer to source value (PTS value) consistent with disclosed embodiments. The PTS value can be constructed to reduce the possibility of a rate of energy storage or discharge sufficient to damage storage component(s) 1105. The PTS value can be determined according to a formula including a safe zone. The PTS value can remain unchanged while the charging or discharging rate falls within the safe zone. When the charging rate exceeds maximum safe charging value, the PTS value can increase towards a maximum value. When the discharging rate exceeds a maximum safe discharge rate, the PTS value can decrease towards a minimum value. FIG. 14 provides an example of determining a PTS value.

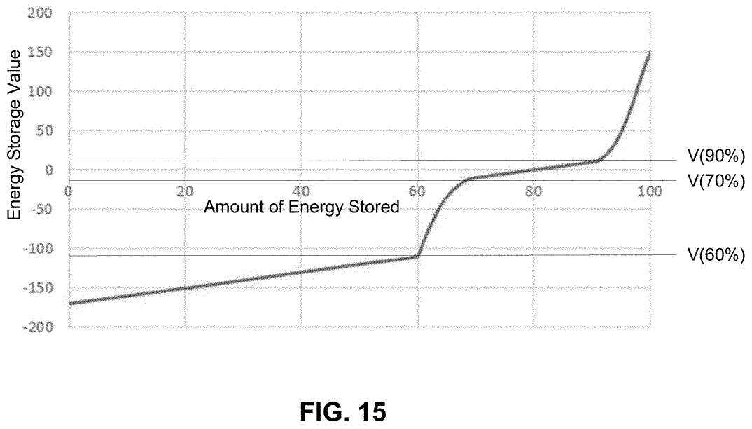

In step 1306 of method 1300, backup controller 1103 can be configured to determine a stored energy value consistent with disclosed embodiments. The stored energy value can be constructed to prevent storage component(s) 1105 from being overcharged, while ensuring a minimum level of energy is available for resiliency in case power source 1113 fails or power consumption suddenly increases. The relationship between the amount of stored energy and the stored energy value can be structured such that the stored energy value decreases (thereby promoting energy storage) as the amount of stored energy decreases below a first threshold value. The decrease can be more than linear (e.g., quadratic or a higher power). Once the amount of stored energy decreases below a second threshold value, lower than the first threshold value, the stored energy value may decrease by a second rate. The decrease can be linear. The relationship between the amount of stored energy and the stored energy value can further be structured such that the stored energy value increases (thereby promoting energy discharge) as the amount of stored energy increases above a third threshold value. The increase can be more than linear (e.g., quadratic or a higher power). As the amount of stored energy increases between the first and third threshold values, the stored energy value may increase by a fourth rate. This increase can be linear. FIG. 15 provides an example of determining a stored energy value.

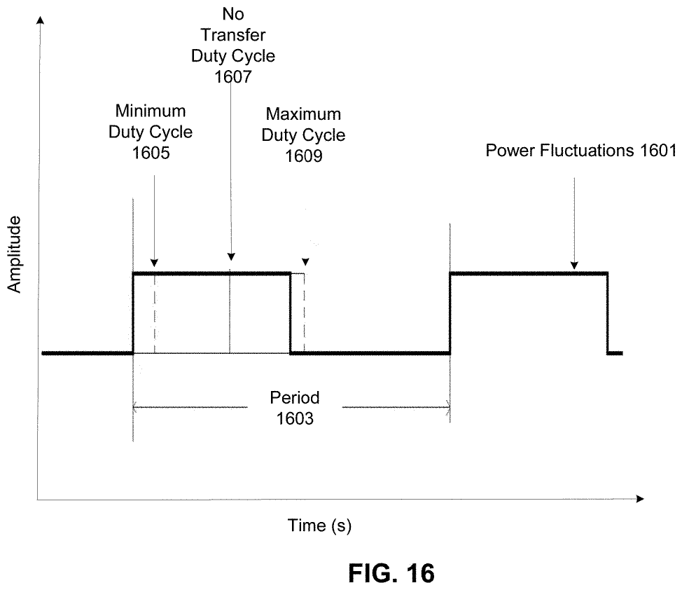

In step 1307 of method 1300, backup controller 1103 can be configured to determine a power boundary value, consistent with disclosed embodiments. In some embodiments, power source 1113 can indicate power requirements of power source 1113 using the power boundary value. For example, when power source 1113 is overloaded, it can indicate that power system 1102 should rely less on power source 1113, or even provide power to power source 1113. As an additional example, when power source 1113 has surplus power, it can signal that power system 1102 should rely more on power provided by power source 1113. The power boundary value can depend on data encoded into fluctuations in power in external power bus 1125 or, in some embodiments, internal power bus 1123. Such data can be decoded by interface controller 1111 or, in some embodiments, backup controller 1103. The difference in the duty cycle between a setpoint duty cycle and the duty cycle of the signal can be used to generate the power boundary value. In this manner, power source 1113 can indicate its power requirements by changing the duty cycle of power fluctuations in power provided on external power bus 1125. FIG. 16 provides an example of determining a power boundary value.

In step 1309 of method 1300, backup controller 1103 can be configured to determine a control value based on at least one of the PTS value, the stored energy value, or the power boundary value. The values used and the manner in which the control value is calculated from the at least one of the PTS value, the stored energy value, or the power boundary value can be predetermined. In some embodiments, the control value can be a sum of the three values. In various embodiments, the control value can be a weighted sum, with the weights reflecting the relative importance of the three values in the managing power system 1102.

In step 1311 of method 1300, backup controller 1103 can be configured to adjust the transfer of power between external power bus 1125 and internal power bus 1123 based on the control value. Backup controller 1103 can be configured to adjust the power transfer value by providing instructions to interface controller 1111. In some embodiments, the power transfer value can be adjusted between a maximum value of power transfer to internal power bus 1123, corresponding to control values less than a minimum threshold value, to a maximum value of power transfer to external power bus 1125, corresponding to control values greater than a maximum threshold value. For example, the interface controller 1111 can be set proportionally to the control value between control values of -100 and 100, with -100 representing maximum power from external power bus 1125 to internal power bus 1123 and 100 representing maximum power from internal power bus 1123 to external power bus 1125.

In step 1313 of method 1300, backup controller 1103 can be configured to start or stop power generation by generation component(s) 1107. For example, the controller can provide instructions to configure renewable power generation sources such as wind turbine or solar panels to contribute power to the power grid. As an additional example, the controller can provide instructions to start or stop generators connected to the power grid, such as gas peaking plants or other power plants. Thus, backup controller 1103 can manage power transfer to internal power bus 1123 by a generator component of power system 1102 based on the control value.

In some embodiments, generation component(s) 1107 can be operating in on/off mode at maximum power with a hysteresis given by the control value. Generation component(s) 1107 can be started when the control value goes below a first threshold value (e.g., a value of −50 on a scale of −100 to 100, where 0 indicates no net power transfer—indicating a need for power), ramped to maximum power, and operated at maximum power until the control value goes above a second threshold value (e.g., a value of 25 on a scale of −100 to 100, where 0 indicates no net power transfer—indicating power generation is no longer required). The particular amount of hysteresis and the particular threshold values set can be specific to a power system and the value provided herein are not intended to be limiting. When the control value goes above the second threshold value, generation component(s) 1107 can be ramped down to zero and then shut down. In various embodiments, backup controller 1103 can be configured to start and stop ones of generation component(s) 1107 based on criteria such dispatchability and marginal cost of power generation. In some embodiments, solar photovoltaic power generation can be linearly limited for control values between two threshold values. For example, as a control value increases from a first threshold value to a second threshold value, the power contribution of a solar photovoltaic power generator to internal power bus 1123 can taper linearly from a maximum value (e.g., all power generated, or capable of generation, should be supplied) to a minimum value (e.g., zero power). When the control value is less than the first threshold value, the contribution of solar photovoltaic power generation to internal power bus 1123 should be maximized (e.g., the solar photovoltaic power generator should be configured to maximize power transferred to internal power bus 1123). When the control value is greater than the second threshold value, the contribution of solar photovoltaic power generation to internal power bus 1123 can be minimized (e.g., the solar photovoltaic power generator should be configured to minimize, or set to zero, the power transferred to internal power bus 1123). The first threshold value can be set to correspond to a situation in which interface controller 1111 transfers at least some power from internal power bus 1123 to external power bus 1125 (e.g., a value of 50 on a scale of −100 to 100, where 0 indicates no net power transfer between internal power bus 1123 and external power bus 1125). The second threshold value can be set to correspond to a situation in which interface controller 1111 transfer a maximum amount of power from internal power bus 1123 to external power bus 1125 (e.g., a value of 100 on a scale of −100 to 100) The particular thresholds values set can be specific to a power system and the values provided herein are not intended to be limiting.

In step 1313, backup controller 1103 can be configured to shed loads on power system 1102. In some embodiments, backup controller 1103 can be configured to manage power system 1102 by providing instructions to adjust power consumption, start or stop, or reschedule the actions of load(s) 1109. In some embodiments, backup controller 1103 can be configured to select one(s) of load(s) 1109 when the control value exceeds a first threshold. Ones of load(s) 1109 can be selected for stopping or rescheduling based on a priority value associated with each load. In some embodiments, when the control value is less than a first threshold, but not less than a second threshold, only loads with less than a first priority can be stopped or rescheduled. In various embodiments, when the control value is less than the second threshold, any load with less than a second priority greater than the first priority can be stopped or rescheduled. In some embodiments, loads with a third priority greater than the second priority may not be stopped or rescheduled.

In step 1315, backup controller 1103 can be configured to determine whether to exit the backup mode or continue controlling power system 1102. As described above, backup controller 1103 can be configured to return to normal operation mode when a reset condition is satisfied.

FIG. 14 depicts an exemplary dependence of a PTS value on power transfer, consistent with disclosed embodiments. The x-axis of FIG. 14 is time, while one y-axis depicts a magnitude of power transfer 1401 and the second y-axis depicts a magnitude of the PTS value. As shown in FIG. 14, when a value of power transfer 1401 exceeds maximum threshold 1403, the PTS value 1411 can increment towards maximum value 1407. When the value of power transfer 1401 decreases below minimum threshold 1405, the PTS value 1411 can decrement towards minimum value 1407.

As a non-limiting example, when storage component(s) 1105 includes a battery having a maximum charging rate P_{cmax}, the PTS value 1411 when the charging rate exceeds P_{cmax} can be calculated as:

C(t)=α(Pcmax−P(T))+C(t−1)

where C(t) is the current PTS value, a is a positive scaling value (which in some embodiments could depend on the time Δt since the last calculation of PTS value), and C(t−1) is the last calculated PTS value. In this example, C(t)>C(t−1). When the calculated value of C(t) would exceed the maximum value (e.g., maximum value 1407), C(t) can be clamped to the maximum value.

When the maximum discharge rate is P_{dmax}, the PTS value 1411 when discharge rate exceeds P_{dmax} can be calculated as:

C(t)=β(P(T)−P_{dmax})+C(t−1)

where C(t) is the current PTS value, β is a positive scaling value (which in some embodiments could depend on the time At since the last calculation of the PTS value), and C(t−1) is the last calculated PTS value. In this example, C(t)≤C(t−1). When the calculated value of C(t) would be less than the minimum value (e.g., minimum value 1409), C(t) can be clamped to the minimum value.

In this non-limiting example, the maximum recommended charging and discharging powers can be functions of the temperature of the battery. These values can depend on the battery chemistry and can be provided by the manufacturer of the battery.

When the battery power is between the maximum recommended discharge and change powers (e.g., Pdmax and Pcmax) the PTS value can be updated as:

C(t)=y*sgn(C(t−1)) * max(|C(t−1)|+d, 0)

where sgn(C(t−1)) is the sign of C(t−1) and d is a negative-valued reduction factor governing how quickly the PTS value increments towards zero and y is is a positive scaling value (which in some embodiments could depend on the time At since the last calculation of PTS value).

FIG. 15 depicts an exemplary dependence of a stored energy value on an amount of stored energy in storage component(s) 1105, consistent with disclosed embodiments. In this non-limiting example, storage component(s) 1105 includes a battery and the x-axis in FIG. 15 depicts a state of charge of the battery (ranging from 0%, fully discharged, to 100%, fully charged). The y-axis depicts the stored energy value. As a non-limiting example, when the state of charge is above 90% the stored energy value can be given by:

V=α* (SOC−90%)²+V(90%)

Where V(90%) is the value of V at a state of charge of 90% and a is a scaling factor. If the state of charge is below 70% but above 60% the stored energy value can be given by:

V=−β* (70%−SOC)²−V(60%)

Where V(60%) is the value of V at a state of charge of 60% and β is a scaling factor. As the state of charge drops below 60%, the V can decrease linearly from V(60%):

V=−γ(60%−SOC)−V(60%)

Where y is a scaling factor. V(60%) can be chosen such that V=0 at the desired state of charge of the battery (e.g., V(80%)=0). In some embodiments, the scaling factors can be chosen such that the maximum value of V over the full range of states of charge is less than the maximum value for the power transfer value (e.g., maximum value 1407). Similarly, the scaling factors can be chosen so that the minimum value of V over the full range of states of charge is less than the minimum value for the power transfer value (e.g., minimum value 1409).

FIG. 16 depicts an exemplary dependence of a power boundary value on information encoded into an external power supply, consistent with disclosed embodiments. The external power supply can have a time-varying amplitude, as depicted in FIG. 16. This time-varying amplitude can include power fluctuations 1601. In the depicted non-limiting example, power fluctuations 1601 includes a pulse train with a period 1603 between pulses and a variable duty cycle that conveys information about the power requirements of power source 1113. A duty cycle of a pulse in the pulse train at no transfer duty cycle value 1607 can signal that power source 1113 is requesting no power transfer between external power bus 1125 and internal power bus 1123. A duty cycle of a pulse in the pulse train at minimum duty cycle value 1605 can signal that power source 1113 is requesting to transfer the maximum amount of power from external power bus 1125 to internal power bus 1123. A duty cycle of a pulse in the pulse train at maximum duty cycle value 1609 can signal that power source 1113 is requesting to transfer the maximum amount of power to external power bus 1125 from internal power bus 1123. In some embodiments, the requested transfer can vary linearly with changes in duty cycle between these extremes.

The foregoing description has been presented for purposes of illustration. It is not exhaustive and is not limited to precise forms or embodiments disclosed. Modifications and adaptations of the embodiments will be apparent from consideration of the specification and practice of the disclosed embodiments. For example, the described implementations include hardware, but systems and methods consistent with the present disclosure can be implemented with hardware and software. In addition, while certain components have been described as being coupled to one another, such components can be integrated with one another or distributed in any suitable fashion.

Moreover, while illustrative embodiments have been described herein, the scope includes any and all embodiments having equivalent elements, modifications, omissions, combinations (e.g., of aspects across various embodiments), adaptations or alterations based on the present disclosure. The elements in the claims are to be interpreted broadly based on the language employed in the claims and not limited to examples described in the present specification or during the prosecution of the application, which examples are to be construed as nonexclusive. Further, the steps of the disclosed methods can be modified in any manner, including reordering steps or inserting or deleting steps.

The features and advantages of the disclosure are apparent from the detailed specification, and thus, it is intended that the appended claims cover all systems and methods falling within the true spirit and scope of the disclosure. As used herein, the indefinite articles “a” and “an” mean “one or more.” Similarly, the use of a plural term does not necessarily denote a plurality unless it is unambiguous in the given context. Further, since numerous modifications and variations will readily occur from studying the present disclosure, it is not desired to limit the disclosure to the exact construction and operation illustrated and described, and accordingly, all suitable modifications and equivalents may be resorted to, falling within the scope of the disclosure.

As used herein, unless specifically stated otherwise, the term “or” encompasses all possible combinations, except where infeasible. For example, if it is stated that a component may include A or B, then, unless specifically stated otherwise or infeasible, the component may include A, or B, or A and B. As a second example, if it is stated that a component may include A, B, or C, then, unless specifically stated otherwise or infeasible, the component may include A, or B, or C, or A and B, or A and C, or B and C, or A and B and C.

The embodiments may further be described using the following clauses:

1. A smart interface controller for managing power transfer in a distributed power transmission system, comprising: at least one processor; and at least one memory storing instructions that, when executed by the at least one processor, cause the smart interface controller to perform operations comprising: receiving, from a first node including an energy storage component, a first power transfer request for the first node, the first power transfer request indicating a requested power transfer value based at least in part on a status of the energy storage component; receiving, from a second node, a second power transfer request for the second node; determining a power transfer value between the first node and the second node based at least in part on the first power transfer request and the second power transfer request; providing, to a power converter, instructions to transfer power between the first node and the second node according to the determined power transfer value.

2. The smart interface controller of clause 1, wherein: determining the power transfer value comprises determining that the power transfer value satisfies a maximum power transfer criterion specified in the first power transfer request; and in response to satisfaction of the maximum power transfer criterion, setting the determined power transfer value to a predetermined value.

3. The smart interface controller of any one of clauses 1 to 2, wherein: the first power transfer request is received over a power connection between the first node and the smart interface controller; or the first power transfer request is received over a communication network connection between the first node and the smart interface controller.

4. The smart interface controller of any one of clauses 1 to 3, wherein: receiving the first power transfer request comprises receiving a time associated with a next first power transfer request.

5. The smart interface controller of any one of clauses 1 to 4, wherein: the operations comprise: repeatedly receiving first power transfer requests and second power transfer requests; and determining the power transfer value using the most recently received of the first power transfer requests and the most recently received of the second power transfer requests.

6. The smart interface controller of any one of clauses 1 to 5, wherein: a combined system includes the smart interface controller and the first node; or the combined system includes the smart interface controller and the second node.

7. The smart interface controller of any one of clauses 1 to 6, wherein: the determined power transfer value comprises a magnitude and direction of power transfer between the first node and the second node.

8. The smart interface controller of any one of clauses 1 to 7, wherein: the determined power transfer value depends on a priority of the first node and a priority of the second node.

9. The smart interface controller of any one of clauses 1 to 8, wherein: the determined power transfer value depends on a weight associated with the first node and a weight associated with the second node.

10. The smart interface controller of any one of clauses 1 to 9, wherein: the first power transfer request includes a first pattern, the first pattern indicating the requested power transfer value.

11. A power distribution system comprising: a first node including an energy storage component, the first node configured to repeatedly determine first power transfer requests based at least in part on a status of the energy storage component; second nodes including respective energy storage components, the second nodes configured to repeatedly determine second power transfer requests based at least in part on statuses of the respective energy storage components; and at least one smart interface controller configured to transfer power between the first node and the second nodes, the at least one smart interface controller configured to repeatedly update values of the power transfer based on a present first power transfer request and a present second power transfer request.

12. The power distribution system of clause 11, wherein: the second nodes are configured to determine the second power transfer requests based at least in part on at least one of respective historical net power usage, present net power usage, or predicted net power usage by devices connected to the respective second nodes.

13. The power distribution system of clause 12, wherein: the second nodes are configured to determine the second power transfer requests based on the historical net power usage; and the historical net power usage includes an average net power usage over a predetermined period of time.

14. The power distribution system of clause 13, wherein: the predetermined period of time is greater than an hour and less than a month.

15. The power distribution system of any one of clauses 12 to 14, wherein: the second nodes are configured to determine the second power transfer requests based on the predicted net power usage; and the predicted net power usage depends on at least one of historical net power usage or forecasted weather.

16. The power distribution system of any one of clauses 11 to 15, wherein: the first node is further configured to provide instructions to adjust power generation by power sources connected to the first node based at least in part on the repeatedly updated values of the power transfer.

17. The power distribution system of any one of clauses 11 to 16, wherein: one of the second nodes is further configured to provide instructions to adjust power consumption by devices connected to the one of the second nodes based at least in part on the repeatedly updated values of the power transfer.

18. The power distribution system of any one of clauses 11 to 17, wherein: repeatedly determining the first power transfer requests comprises repeatedly determining requested magnitudes and directions of power transfer.

19. The power distribution system of any one of clauses 11 to 18, wherein: the status of the energy storage component comprises state of charge, temperature; or power output of the energy storage component.

20. The power distribution system of any one of clauses 11 to 19, wherein: the at least one smart interface controller is configured to repeatedly update values of the power transfer according to a pattern determined based on the present first power transfer request and the present second power transfer request.

21. A power distribution system comprising: a first node configured to maintain a status of a first energy storage component within a first range, at least in part by providing a first power transfer request to at least one smart interface controller; second nodes configured to maintain statuses of second energy storage components within respective second ranges, at least in part by providing respective second power transfer requests to the at least one smart interface controller; and wherein the at least one smart interface controller is configured to determine power transfer values between the first node and the respective second nodes based on at least in part on the first power transfer request and the respective second power transfer requests.

22. The power distribution system of clause 21, wherein: determining power transfer values between the first node and the respective second nodes comprises determining magnitudes and directions of power transfer between the first node and the respective second nodes.

23. The power distribution system of any one of clauses 21 to 22, wherein: the first node is further configured to detect the power transfer values between the first node and the respective second nodes; and provide an updated first power transfer request to the at least one smart interface controller.

24. The power distribution system of clause 23, wherein: the first node is further configured to provide instructions to adjust power generation by power sources connected to the first node.

25. The power distribution system of any one of clauses 21 to 24, wherein: a one of the second nodes is further configured to detect a power transfer value between the first node and the one of the second nodes; and provide instructions to adjust power consumption by devices connected to the one of the second nodes.

26. The power distribution system of any one of clauses 21 to 25, wherein: the at least one smart interface controller is configured to determine the power transfer values based at least in part on respective weights associated with the first node and the second nodes.

27. The power distribution system of any one of clauses 21 to 26, wherein: the first node is further configured to determine the first power transfer request based on the status of the first energy storage component and at least one of a historical power usage, present power usage, or predicted power usage.

28. The power distribution system of any one of clauses 21 to 27, wherein: the first energy storage component comprises a battery; and the status of the first energy storage component comprises at least one of a state of charge, power output, or temperature of the battery.

29. The power distribution system of any one of clauses 21 to 28, wherein: the first power transfer request and the respective second power transfer requests are provided asynchronously.

30. The power distribution system of any one of clauses 21 to 29, wherein: the at least one smart interface controller is configured to determine power transfer values between the first node and the respective second nodes using the first power transfer request and the respective second power transfer requests, without receiving management information from the first node or the respective second nodes.

31. The power distribution system of any one of clauses 21 to 30, wherein: at least one of the first power transfer request and of the respective second power transfer requests includes a pattern comprising power transfer values associated with times.

32. A community DC power distribution system comprising: a community node comprising a voltage source, a first switch, and a second switch; a power distribution loop comprising: first power distribution lines (i) configured to be grounded through respective resistances of between 1 kOhm and 100 kOhm, (ii) configured to have a voltage difference of at least 380V, and (iii) electrically connected to the first switch, first local nodes, and a third switch; second power distribution lines (i) configured to be grounded through respective resistances of between 1 kOhm and 100 kOhm, (ii) configured to have a voltage difference of at least 380V, and (iii) electrically connected to the second switch, second local nodes, and the third switch; wherein the community node is configured to provide power to the first local nodes via the first power distribution lines and the first switch when the first switch is in a closed state, and wherein the community node is configured to provide power to the second local nodes via the second power distribution lines and the second switch when the second switch is in a closed state.

33. The community DC power distribution system of clause 32, wherein the community node is configured to provide power to the first local nodes via the first distribution lines and the second local nodes via the second distribution lines when: the first switch is in an open state, the second switch is in a closed state, and the third switch is in a closed state, or the first switch is in a closed state, the second switch is in an open state, and the third switch is in a closed state.

34. The community DC power distribution system of any one of clauses 32 to 33, further comprising: third power distribution lines (i) configured to be grounded through respective resistances of between 1 kOhm and 100 kOhm, (ii) configured to have a voltage difference of at least 380V, and (iii) electrically connected to the second switch, and third local nodes, wherein the community node is configured to provide power to the third local nodes via the third power distribution lines when the second switch is in a closed state.

35. The community DC power distribution system of clause 34, wherein: the second switch is configured to transition from a closed state to an open state to isolate the third local nodes, based on a fault in the third power distribution lines; the third switch is configured to transition from a closed state to an open state based on the fault; and the community node is configured to provide power to the first local nodes via the first power distribution lines and to provide power to the second local nodes via the second power distribution lines.

36. The community DC power distribution system of any one of clauses 32 to 35, wherein the first power distribution lines comprise a positive line and negative line jointly installed in a single conduit.

37. The community DC power distribution system of any one of clauses 32 to 36, wherein the first power distribution lines are configured for direct burial.

38. The community DC power distribution system of any one of clauses 32 to 37, wherein a length of the first power distribution lines is configured to limit a capacitive energy storage of the first power distribution lines is less than 10 Joules .

39. The community DC power distribution system of any one of clauses 32 to 38, wherein the first power distribution lines are divided into two portions by a fourth switch, the fourth switch configured to isolate at least one of the two portions from the community node when the fourth switch is in an open state and one of: the first switch is in a closed state and the third switch is in an open state, or the first switch is in an open state, the third switch is in a closed state, and the second switch is in a closed state.

40. The community DC power distribution system of any one of clauses 32 to 39, wherein the DC power distribution system has a clover leaf topology.

41. The community DC power distribution system of any one of clauses 32 to 40, wherein at least twenty-five of the first local nodes are associated with respective residences.

42. The community DC power distribution system of any one of clauses 32 to 41, wherein the first power distribution lines are configured to distribute at least 400 amperes.

43. The community DC power distribution system of any one of clauses 32 to 42, wherein the community node further comprises a shunt electrically connected between ones of the first power distribution lines and at least one inductor electrically connected in series with at least one of the first power distribution lines.

44. The community DC power distribution system of any one of clauses 32 to 43, wherein the first local nodes comprise respective local energy storage components, and the community node is configured to charge the respective local energy storage components through the first power distribution lines.

45. The community DC power distribution system of any one of clauses 32 to 44, wherein the community node comprises an energy storage component configured to apply a voltage difference of at least 380V to the first power distribution lines.

46. The community DC power distribution system of any one of clauses 32 to 45, wherein the community node comprises a transformer configured to receive an AC voltage and generate a DC voltage of least 380V.

47. The community DC power distribution system of any one of clauses 32 to 46, wherein the first power distribution lines are configured to have a voltage difference of at least 15,000V.

48. The community DC power distribution system of any one of clauses 32 to 47, wherein a capacitive energy storage of the first power distribution lines is less than 10 Joules when the first power distribution lines have a voltage difference of at least 15,000V.

49. The community DC power distribution system of any one of clauses 32 to 48, wherein the third switch is electrically connected to a switch of a second community DC power distribution system to enable power exchange.

50. The community DC power distribution system of any one of clauses 32 to 49, further comprising a smart interface controller for managing power transfer, the smart interface controller comprising: at least one processor; and at least one memory storing instructions that, when executed by the at least one processor, cause the smart interface controller to perform operations comprising: receiving, from the community node, a first power transfer request for the community node, the first power transfer request indicating a requested power transfer value based at least in part on a status of an energy storage component of the community DC power distribution system; receiving, from a second community DC power distribution system electrically connected to the first switch to enable power exchange between the community DC power distribution system and the second community distribution DC power distribution system, a second power transfer request for the second community DC power distribution system; determining a power transfer value between the community node and the second community DC power distribution system based at least in part on the first power transfer request and the second power transfer request; providing, to a power converter, instructions to transfer power between the first node and the second node according to the determined power transfer value via the third switch.

51. The community DC power distribution system of any one of clauses 32 to 50, wherein: the community node is configured to repeatedly determine first power transfer requests based at least in part on a status of an energy storage component of the community node; the first local nodes comprise respective energy storage components and are configured to repeatedly determine second power transfer requests based at least in part on statuses of the respective energy storage components; and wherein the community DC power distribution system further comprises a smart interface controller configured to transfer power between the community node and the first local nodes, the smart interface controller configured to repeatedly update values of the power transfer based on a present first power transfer request and a present second power transfer request.

52. A method of operating a community DC power distribution system comprising a community node and a power distribution loop, the method comprising: providing power from the community node to first local nodes via first power distribution lines of the power distribution loop, the first power distribution lines being (i) configured to be grounded through respective resistances of between 1 kOhm and 100 kOhm, (ii) configured to have a voltage difference of at least 380V, and (iii) electrically connected to the first switch, first local nodes, and a third switch; providing power from the community node to second local nodes via second power distribution lines of the power distribution loop, the second power distribution lines being (i) configured to be grounded through respective resistances of between 1 kOhm and 100 kOhm, (ii) configured to have a voltage difference of at least 380V, and (iii) electrically connected to the second switch, second local nodes, and the third switch; detecting a fault in the community DC power distribution system; and transitioning, based on the detected fault, the second switch from a closed state to an open state based on the presence of the fault.

53. The method of clause 52, the method further comprising: transitioning the third switch from an open state to a closed state; and providing power from the community node to the second power distribution lines via the first switch, the first power distribution lines, and the third switch.

54. The method any one of clauses 52 to 53, wherein the third switch is in an open state when the second switch transitions from a closed state to an open state, and transitioning the second switch from a closed state to an open state isolates a portion of the second power distribution lines between the second switch and the third switch from the community node.

55. The method of clause 54, wherein the second power distribution lines are electrically connected to a fourth switch, and the method further comprises: transitioning the fourth switch from a closed state to an open state to isolate a first portion of the second power distribution lines from the community node; transitioning the third switch from an open state to a closed state; and providing power from the community node to the second portion of the second power distribution lines via the first switch, the first power distribution lines and the third switch.

56. The method of any one of clauses 52 to 55, wherein the fault is associated with the second switch.

57. The method of any one of clauses 52 to 56, wherein the fault is associated with the second power distribution lines and transitioning the second switch from a closed state to an open state isolates at least a portion of the second power distribution lines from the community node.

58. The method of any one of clauses 52 to 57, wherein: the second switch is electrically connected to third power distribution lines, the third power distribution lines being (i) configured to be grounded through respective resistances of between 1 kOhm and 100 kOhm, (ii) configured to have a voltage difference of at least 380V, and (iii) electrically connected to third local nodes and a fourth switch; and the method further comprises transitioning the fourth switch from an open state to a closed state to provide power from the community node to the third power distribution lines via the fourth switch.

59. The method of clause 58, wherein the third power distribution lines are components of another power distribution loop.

60. The method of any one of clauses 52 to 59, wherein providing power from the community node to the first local nodes comprises providing at least 400 amperes current.

61. The method of any one of clauses 52 to 60, wherein the first power distribution lines are configured to have a voltage of at least 15,000V.

62. The method of any one of clauses 52 to 61, wherein the first power distribution lines providing the power from the community node to the first local nodes have a capacitive energy storage of less than 10 Joules.

63. A method of detecting ground faults in a DC power distribution system including a first power line connected to local nodes, and a second power line connected to the local nodes, the method comprising: applying a voltage of at least 380V to the first power line and second power line, the first power line configured to be grounded through a resistance of between 1 kOhm and 100 kOhm, the second power line configured to be grounded through a resistance of between 1 kOhm and 100 kOhm; determining that the first power line and second power line have an asymmetry in voltage with respect to ground; detecting a ground fault based on the asymmetry and a threshold asymmetry; and providing an indication of the ground fault.

64. A method of detecting power supply faults in a DC power distribution system including a first power line connected to a switch and local nodes and a second power line connected to the local nodes, the method comprising: applying a voltage of at least 380V to the first power line and second power line, the first power line being configured to be grounded through a resistance of between 1 kOhm and 100 kOhm, the second power line being configured to be grounded through a resistance of between 1 kOhm and 100 kOhm; determining a present voltage between the first and second power lines; and transitioning the switch to an open state based on the present voltage and a threshold.

65. The method of clause 64, wherein the threshold difference is an over voltage threshold.

66. The method of any of clauses 64 to 65, wherein the threshold difference is an under-voltage threshold.

67. A community DC power distribution system comprising: a first power line connected to a switch and local nodes and an inductor configured to provide a maximum rate of change in current, the first power line having a capacity of at least 400 amps; and a second power line connected to the local nodes, the second power line having a capacity of at least 400 amps; a community node configured to apply a voltage of between 500V and 1000V to the first power line and second power line; a processor configured to detect a rate of change of a current in one of the first power line or the second power line and transition a switch from a closed state to an open state based on the rate of change of the current.

68. A method of detecting faults in a DC power distribution system comprising a first power line connected to a switch and local nodes and a second power line connected to the local nodes, the method comprising: applying a voltage of at least 380V to the first power line and second power line, the first power line being configured to be grounded through a resistance of between 1 kOhm and 100 kOhm, the second power line being configured to be grounded through a resistance of between 1 kOhm and 100 kOhm; detecting a first rate of change of voltage with respect to ground in the first power line; detecting a second rate of change of voltage with respect to ground in the second power line; and performing at least one of one of: transitioning the switch to an open state based on at least one of the first rate, the second rate, or a difference between the first rate and the second rate; decoding a communication message based on at least one of the first or second rate; or transmitting a notification to a control center associated with the DC power distribution system, the notification comprising information indicating at least one of the first rate, the second rate, or a difference between the first and second rate.

69. A method of detecting faults in a DC power distribution system comprising a first power line connected to a switch and local nodes and a second power line connected to the local nodes, the method comprising: applying a voltage of at least 380V to the first power line and second power line, the first power line being configured to be grounded through a resistance of between 1 kOhm and 100 kOhm, the second power line being configured to be grounded through a resistance of between 1 kOhm and 100 kOhm; detecting a rate of change of voltage with respect to ground in the first power line; transitioning the switch to an open state based on a difference a magnitude of the rate of change of voltage.

70. A multi-mode management system, comprising: a first controller configured to control a power system; a second controller configured to: in a first mode, estimate a state of the power system by monitoring communications between the first controller and the power system, and in response to satisfaction of a first condition, switch to a second mode; and in the second mode, disable communication between the first controller and the power system and control the power system based on the estimated state of the power system.

71. The management system of clause 70, wherein disabling communication between the first controller and the power system comprises physically disconnecting the first controller from the power system.

72. The management system of clause 70, wherein disabling communication between the first controller and the power system comprises ceasing relaying messages between the first controller and the power system.

73. The management system of any one of clauses 70 to 72, wherein the first condition comprises receiving an instruction to enter the second mode.

74. The management system of clause 73, wherein the instruction is received from the first controller or a supervisory device.

75. The management system of any one of clauses 70 to 74, wherein the first condition comprises a failure of the first controller to contact the second controller for a predetermined amount of time.

76. The management system of any one of clauses 70 to 74, wherein the first condition comprises a failure of the first controller to request status information of the power system for a predetermined amount of time.

77. The management system of any one of clauses 70 to 74, wherein the first condition depends on the estimated state of the power system.

78. The management system of any one of clauses 70 to 74, wherein the first condition comprises provision, by the first controller, of a command to the power system that would result the failure or abnormal operation of the power system.

79. The management system of any one of clauses 70 to 78, wherein: in the first mode, the second controller is further configured to provide, to the first controller, a decoded signal indicating the power requirements of a second system.

80. The management system of clause 79, wherein: the second controller is configured to receive the decoded signal from an interface controller connecting the power system to the second system.

81. The management system of clause 79, wherein: the second controller is configured to decode the signal from an internal power bus connected to the second system through an interface controller.

82. A management system, comprising: a first controller configured to control a power system using an internal communication network, the first controller configurable through an external communication network; and a second controller configured to: monitor communications between the first controller and the power system on the internal communication network; in a first mode, permit communication between the first controller and the power system and, in response to satisfaction of a first condition, enter a second mode; and in the second mode, disable communication between the first controller and the power system and control the power system using the internal communication network.

83. The management system of clause 82, wherein: the second controller is further configured to, in the second mode, receive communications from the first controller and, in response to satisfaction of a second condition, enter the first mode.

84. The management system of any one of clauses 82 to 83, wherein: the first condition comprises receiving, at an input separate from the internal communication network or the external communication network, an instruction to enter the second mode.

85. The management system of any one of clauses 82 to 84, wherein: wherein the second controller is configured as a slave in the internal communication network in the first mode and as a master in the internal communication network in the second mode.

86. The management system of any one of clauses 82 to 85, wherein: the first controller is configured to communicate with an interface controller to set a power transfer value in the first mode, and the second controller is configured to communicate with the interface controller to set a power transfer value in the second mode.

87. The management system of any one of clauses 82 to 86, wherein: the first controller is configured to communicate with an interface controller indirectly through the second controller.

88. The management system of any one of clauses 82 to 87, wherein: the internal communication network uses at least one of a MODBUS or CANBUS network.

89. The management system of any one of clauses 82 to 88, wherein: the second controller is not configurable through the internal communication network or the external communication network.

90. A power system, comprising: a backup controller configured to: in a first mode, forward communications received from a storage component of a power system to a primary controller; and in a second mode: determine a control value based on at least one of: a power transfer rate of the storage component; a state of charge of the storage component; or a power boundary value; determine, based on the control value, a value of power transfer between an external power bus connected to an external power source and an internal power bus connected to the storage component; and provide, to an interface device that controls power transfer between the external power bus and the internal power bus, a request to transfer power between the external power bus and the internal power bus based on the power transfer value.

91. The power system of clause 90, wherein: the backup controller is further configured to: decode the power boundary value from a voltage signal on the internal power bus; or receive the decoded power boundary value from the interface device; and the control value is based, at least in part, on the power boundary value.

92. The power system of any one of clauses 90 to 91, wherein: the request includes instructions that, when executed by the interface device, configure the interface device to transfer power between the external power bus and the internal power bus based on the power transfer value.

93. The power system of any one of clauses 90 to 92, wherein: the backup controller is further configured to, in the second mode: manage power transfer to the internal power bus by a generator component of the power system based on the control value.

94. The power system of one of clauses 90 to 93, wherein: in the second mode, the control value is periodically determined with a period of less than 100 seconds.

95. The power system of one of clauses 90 to 94, wherein: in the second mode, the control value is repeatedly determined.

96. The power system of one of clauses 90 to 95, wherein: at least one of the external power bus or the internal power bus is a DC power bus.

97. The power system of one of clauses 90 to 96, wherein: the power transfer value includes a magnitude of power transfer and a direction of power transfer.

100. The power system of one of clauses 90 to 96, wherein: the power transfer value includes a magnitude of power transfer and a direction of power transfer.

101. The community DC power distribution system of any one of clauses 32 to 51, wherein at least one of local nodes includes a smart interface controller as recited in any one of clauses 1 to 10 or wherein the community DC power distribution system comprises a power distribution system including a smart interface controller as recited in any one of clauses 11 to 31.

102. The community DC power distribution system of clause 101, wherein the smart interface controller comprises the first controller recited in any one of clauses 70 to 89 and the at least one of the local nodes further comprises the second controller recited in any one of clauses 70 to 89 or the backup controller recited in any one of clauses 90 to 100.

103. The community DC power distribution system of any one of clauses 32 to 51, 100, or 101, further configured to operate as recited in any one of 52 to 69.

104. A node including: a smart interface controller as recited in any one of clauses 1 to 31; the smart interface controller comprising the first controller recited in any one of clauses 70 to 89 and the node further comprises the second controller recited in any one of clauses 70 to 89 or the backup controller recited in any one of clauses 90 to 100.

Other embodiments will be apparent from consideration of the specification and practice of the embodiments disclosed herein. It is intended that the specification and examples be considered as example only, with a true scope and spirit of the disclosed embodiments being indicated by the following claims.

What is claimed:

1. A community DC power distribution system comprising:
a community node comprising a voltage source, a first switch, and a second switch;
a power distribution loop comprising:
first high-voltage power distribution lines grounded through first sensor resistors and electrically connected to the first switch, first local nodes, and a third switch;
second high-voltage power distribution lines grounded through second sensor resistors and electrically connected to the second switch, second local nodes, and the third switch;
wherein the community node is configured to provide power to the first local nodes via the first high-voltage power distribution lines and the first switch when the first switch is in a closed state, and
wherein the community node is configured to provide power to the second local nodes via the second high-voltage power distribution lines and the second switch when the second switch is in a closed state.

2. The community DC power distribution system of claim 1, wherein the community node is configured to provide power to the first local nodes via the first high-voltage power distribution lines and the second local nodes via the second high-voltage power distribution lines when:
the first switch is in an open state, the second switch is in a closed state, and the third switch is in a closed state, or
the first switch is in a closed state, the second switch is in an open state, and the third switch is in a closed state.

3. The community DC power distribution system of claim 1, further comprising:
third high-voltage power distribution lines (i) configured to be grounded through third sensor resistors having respective resistances of between 1 kOhm and 100 kOhm, (ii) configured to have a voltage difference of at least 380V, and (iii) electrically connected to the second switch, and third local nodes,
wherein the community node is configured to provide power to the third local nodes via the third high-voltage power distribution lines when the second switch is in a closed state.

4. The community DC power distribution system of claim 3, wherein:
the second switch is configured to transition from a closed state to an open state to isolate the third local nodes, based on a fault in the third high-voltage power distribution lines;
the third switch is configured to transition from a closed state to an open state based on the fault; and
the community node is configured to provide power to the first local nodes via the first high-voltage power distribution lines and to provide power to the second local nodes via the second high-voltage power distribution lines.

5. The community DC power distribution system of claim 1, wherein the first high-voltage power distribution lines comprise a positive line and negative line jointly installed in a single conduit.

6. The community DC power distribution system of claim 1, wherein the first high-voltage power distribution lines are configured for direct burial.

7. The community DC power distribution system of claim 1, wherein a length of the first high-voltage power distribution lines is configured to limit a capacitive energy storage of the first high-voltage power distribution lines to less than 10 Joules.

8. The community DC power distribution system of claim 1, wherein the first high-voltage power distribution lines are divided into two portions by a fourth switch, the fourth switch configured to isolate at least one of the two portions from the community node when the fourth switch is in an open state and one of:
the first switch is in a closed state and the third switch is in an open state, or
the first switch is in an open state, the third switch is in a closed state, and the second switch is in a closed state.

9. The community DC power distribution system of claim 1, wherein the DC power distribution system has a clover leaf topology.

10. The community DC power distribution system of claim 1, wherein at least twenty-five of the first local nodes are associated with respective residences.

11. The community DC power distribution system of claim 1, wherein the first high-voltage power distribution lines are configured to distribute at least 400 amperes.

12. The community DC power distribution system of claim 1, wherein the community node further comprises a shunt electrically connected between ones of the first high-voltage power distribution lines and at least one inductor electrically connected in series with at least one of the first high-voltage power distribution lines.

13. The community DC power distribution system of claim 1, wherein the first local nodes comprise respective local energy storage components, and the community node is configured to charge the respective local energy storage components through the first high-voltage power distribution lines.

14. The community DC power distribution system of claim 1, wherein the community node comprises an energy storage component configured to apply a voltage difference of at least 380V to the first power distribution lines.

15. The community DC power distribution system of claim 1, wherein the community node comprises a transformer configured to receive an AC voltage and generate a DC voltage of least 380V.

16. The community DC power distribution system of claim 1, wherein the first high-voltage power distribution lines are configured to have a voltage difference of at least 15,000V.

17. The community DC power distribution system of claim 1, wherein a capacitive energy storage of the first high-voltage power distribution lines is less than 10 Joules when the first high-voltage power distribution lines have a voltage difference of at least 15,000V.

18. The community DC power distribution system of claim 1, wherein the third switch is electrically connected to a switch of a second community DC power distribution system to enable power exchange.

19. The community DC power distribution system of claim 1, further comprising a smart interface controller for managing power transfer, the smart interface controller comprising:
at least one processor; and
at least one memory storing instructions that, when executed by the at least one processor, cause the smart interface controller to perform operations comprising:
receiving, from the community node, a first power transfer request for the community node, the first power transfer request indicating a requested power transfer value based at least in part on a status of an energy storage component of the community DC power distribution system;
receiving, from a second community DC power distribution system electrically connected to the first switch to enable power exchange between the community DC power distribution system and the second community distribution DC power distribution system, a second power transfer request for the second community DC power distribution system;
determining a power transfer value between the community node and the second community DC power distribution system based at least in part on the first power transfer request and the second power transfer request;
providing, to a power converter, instructions to transfer power between the first node and the second node according to the determined power transfer value via the third switch.

20. The community DC power distribution system of claim 1, wherein:
the community node is configured to repeatedly determine first power transfer requests based at least in part on a status of an energy storage component of the community node;
the first local nodes comprise respective energy storage components and are configured to repeatedly determine second power transfer requests based at least in part on statuses of the respective energy storage components; and
wherein the community DC power distribution system further comprises a smart interface controller configured to transfer power between the community node and the first local nodes, the smart interface controller configured to repeatedly update values of the power transfer based on a present first power transfer request and a present second power transfer request.
